(19) United States
(12) Patent Application Publication
(10) Pub. No.: US 2019/0101140 A1
(43) Pub. Date: Apr. 4, 2019

(54) HYDRAULIC CONTROL DEVICE FOR AUTOMATIC TRANSMISSION AND METHOD FOR MANUFACTURING THE SAME

(71) Applicant: AISIN AW CO., LTD., Anjo-shi, Aichi-ken (JP)

(72) Inventors: Kaname MATSUYAMA, Anjo (JP); Eikichi KIDOKORO, Anjo (JP); Kazuyuki NODA, Anjo (JP); Atsushi MORI, Anjo (JP); Katsuhiro MAENO, Anjo (JP); Yukinobu YAMAGATA, Yokohama (JP)

(73) Assignee: AISIN AW CO., LTD., Anjo-shi, Aichi-ken (JP)

(21) Appl. No.: 16/086,849

(22) PCT Filed: Apr. 20, 2017
(86) PCT No.: PCT/JP2017/015929

§ 371 Date: Sep. 20, 2018

(30) Foreign Application Priority Data
Apr. 20, 2016 (JP) 2016-084720
Sep. 30, 2016 (JP) 2016-194855

(51) Int. Cl. F15B 13/08

(52) U.S. Cl. CPC F15B 13/0892; F15B 13/0871; F16H 61/0009; F15B 13/0857; F15B 13/0896; F15B 13/0814

(57) ABSTRACT

A hydraulic control device for an automatic transmission, the hydraulic control device including: a first layer having a first parting surface and a plurality of first grooves formed in the first parting surface; and a second layer that has a second parting surface and a plurality of second grooves formed in the second parting surface and facing the plurality of first grooves, and that is stacked on the first layer in a stacking direction with the second parting surface facing the first parting surface of the first layer, so that the plurality of first grooves and the plurality of second grooves form a plurality of first oil passages.

### BACKGROUND

The present disclosure relates to hydraulic control devices for automatic transmissions that are mounted on, e.g., vehicles and methods for manufacturing the same.

Conventionally, hydraulic control devices for automatic transmissions which include a valve body having various valves such as a plurality of linear solenoid valves, switch valves, etc. (hereinafter simply referred to as the valves) and oil passages that allow the valves to communicate with each other have been widely used in the art. Valve bodies are typically made of a metal such as aluminum die cast. In recent years, however, valve bodies that are produced by stacking several synthetic resin blocks each having oil passage halves formed by injection molding and joining the stacked blocks into a single piece by welding etc. have been developed (see Japanese Patent Application Publication No. 2012-82917). In such valve bodies formed by stacking synthetic resin blocks, the valves are often disposed so as to extend longitudinally in, e.g., a direction (planar direction) perpendicular to the stacking direction.

Since synthetic resins are less resistant to pressure than metals, it is preferable that the oil passages have a circular section. In the case where the oil passages have a circular section, the oil passages are wider than in the case where the oil passages have a rectangular section. Moreover, since the oil passages are formed between the stacked synthetic resin blocks, the flat parting surfaces of the stacked blocks are welded together between the oil passages that are located adjacent to each other along the parting surfaces of the blocks. Sealability of each oil passage is maintained by the welded portions.

### SUMMARY

In order to reduce the size of the aforementioned valve bodies, it is necessary to reduce the interval between adjacent ones of the oil passages. However, such reduction in interval results in a reduced sealing width between the oil passages and is also not advantageous in terms of strength.

An exemplary aspect of the disclosure provides a hydraulic control device for an automatic transmission and a method for manufacturing the same, which restrains an increase in size of a valve body that is formed by stacking blocks made of a synthetic resin etc., while providing sufficient sealability between oil passages and sufficient strength.

A hydraulic control device for an automatic transmission according to the present disclosure includes: a first layer having a first parting surface and a plurality of first grooves formed in the first parting surface; and a second layer that has a second parting surface and a plurality of second grooves formed in the second parting surface and facing the plurality of first grooves, and that is stacked on the first layer in a stacking direction with the second parting surface facing the first parting surface of the first layer, so that the plurality of first grooves and the plurality of second grooves form a plurality of first oil passages, wherein a first protrusion is formed either between adjacent grooves of the plurality of first grooves on the first parting surface of the first layer so as to protrude toward the second layer or between adjacent grooves of the plurality of second grooves on the second parting surface of the second layer so as to protrude toward the first layer, a first recess in which the first protrusion is fitted is either formed in the second parting surface of the second layer if the first protrusion is formed between the adjacent grooves of the plurality of first grooves, or formed in the first parting surface of the first layer if the first protrusion is formed between the adjacent grooves of the plurality of second grooves, and the first layer and the second layer are stacked such that the first protrusion is fitted in the first recess between adjacent ones of the first oil passages, and are joined via the first protrusion and the first recess.

According to the hydraulic control device for the automatic transmission, the first layer and the second layer are stacked such that the first protrusion is fitted in the first recess between adjacent ones of the first oil passages, and are joined via the first protrusion and the first recess. Such fitting between the first protrusion and the first recess formed in the parting surfaces forms a complex shape between adjacent ones of the first oil passages and thus enhances sealability, as compared to the case where the parting surfaces are flat between adjacent ones of the first oil passages. The width of a sealing portion which achieves similar sealability can thus be made smaller than that of a sealing portion which is required in the case where the parting surfaces are flat between adjacent ones of the first oil passages. The pitch between adjacent ones of the first oil passages can therefore be reduced. Moreover, the first layer and the second layer are joined via the first protrusion and the first recess between adjacent ones of the first oil passages. This structure provides sufficient strength even with a reduced pitch between adjacent ones of the first oil passages because the first layer and the second layer are joined in thick portions. An increase in size of a valve body that is formed by stacking blocks made of a synthetic resin etc. is thus restrained while sufficient sealability between the first oil passages and sufficient strength is achieved, as compared to the case where a protrusion and a recess which are fitted together are not formed in opposing parting surfaces.

### BRIEF DESCRIPTION OF THE DRAWINGS

FIG. 1 is a schematic diagram of a vehicle having mounted thereon a hydraulic control device for an automatic transmission according to a first embodiment.

FIG. 2 is a perspective view of the hydraulic control device according to the first embodiment.

FIG. 3 is a bottom view of the hydraulic control device according to the first embodiment.

FIG. 4 is a sectional view taken along line IV-IV in FIG. 3.

FIG. 5A is an enlarged sectional view showing first oil passages and second oil passages of the hydraulic control device according to the first embodiment.

FIG. 5B is an enlarged exploded view showing the first oil passages and the second oil passages of the hydraulic control device according to the first embodiment.

FIG. 6 is a flowchart illustrating a procedure for molding a valve body of the hydraulic control device according to the first embodiment.

FIG. 7 is a schematic view of a vehicle having mounted thereon a hydraulic control device for a vehicle transmission apparatus according to a second embodiment.

FIG. 8 is a perspective view of the hydraulic control device according to the second embodiment.

FIG. 9 is an exploded perspective view of the hydraulic control device according to the second embodiment.

FIG. 10 is a sectional view of the hydraulic control device according to the second embodiment.

FIG. 11A is an enlarged sectional view showing a separated state of a bonded portion between a first protrusion and a first recess of the hydraulic control device according to the second embodiment.

FIG. 11B is an enlarged sectional view showing the bonded portion between the first protrusion and the first recess of the hydraulic control device according to the second embodiment.

FIG. 12A is an enlarged sectional view showing the bonded portion between the first protrusion and the first recess of the hydraulic control device according to the second embodiment.

FIG. 12B is an enlarged sectional view showing the bonded portion between a first protrusion and a first recess in a modification of the hydraulic control device according to the second embodiment in which the position of clearance is changed.

FIG. 13A is an enlarged sectional view showing the bonded portion between a first protrusion and a first recess in a modification of the hydraulic control device according to the second embodiment in which the sectional shape of the clearance is changed.

FIG. 13B is an enlarged sectional view showing the bonded portion between a first protrusion and a first recess in a modification of the hydraulic control device according to the second embodiment in which the position and sectional shape of the clearance are changed.

FIG. 14 is an enlarged sectional view showing the bonded portion between a first protrusion and a first recess in a modification of the hydraulic control device according to the second embodiment in which the sectional shape of the clearance is changed.

### DETAILED DESCRIPTION OF EMBODIMENTS

### First Embodiment

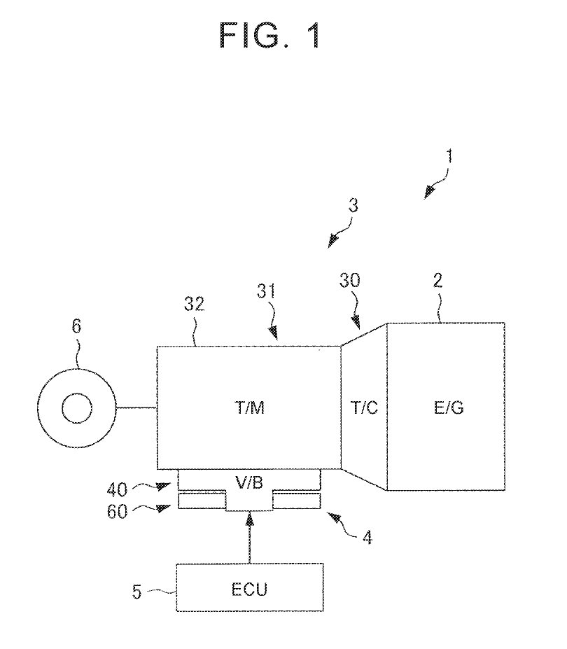

A first embodiment of a hydraulic control device for an automatic transmission will be described below with reference to FIGS. 1 to 6. First, the general configuration of a vehicle 1 on which an automatic transmission 3 is mounted will be described with reference to FIG. 1. As shown in FIG. 1, the vehicle 1 of the present embodiment includes, e.g., an internal combustion engine 2, an automatic transmission 3, a hydraulic control device 4 and an ECU (control device) 5 which control the automatic transmission 3, and wheels 6. The internal combustion engine 2 is an internal combustion engine such as, e.g., a gasoline engine or a diesel engine, and is coupled to the automatic transmission 3. In the present embodiment, the automatic transmission 3 is of what is called a front-engine, rear-drive (FR) type. However, the automatic transmission 3 is not limited to the FR type and may be of a front-engine, front-drive (FF) type. The same hydraulic control device 4 may be used for both the FR type automatic transmission 3 and an FF type automatic transmission. In the present embodiment, the vehicle 1 using only the internal combustion engine 2 as a driving source is described as an example of the vehicle 1 to which the automatic transmission 3 is applied. However, the present disclosure is not limited to this. For example, the present disclosure may be applied to a hybrid vehicle using an internal combustion engine and an electric motor as driving sources.

The automatic transmission 3 has a torque converter 30, a speed change mechanism 31, and a transmission case 32 accommodating these components. The torque converter 30 is interposed between the internal combustion engine 2 and the speed change mechanism 31 and can transmit a driving force of the internal combustion engine 2 to the speed change mechanism 31 via hydraulic fluid. The torque converter 30 has a lockup clutch, not shown, and can directly transmit a driving force of the internal combustion engine 2 to the speed change mechanism 31 by engagement of the lockup clutch. The speed change mechanism 31 is a multi-speed speed change mechanism that can establish a plurality of shift speeds by engagement and disengagement of a plurality of clutches and brakes, not shown. However, the speed change mechanism 31 is not limited to the multi-speed transmission, and may be a continuously variable speed change mechanism such as a belt-type continuously variable automatic speed change mechanism.

The hydraulic control device 4 is formed by, e.g., a valve body. The hydraulic control device 4 can generate a line pressure, a modulator pressure, etc. from oil pressures supplied from an oil pump, not shown, and can supply and cut off supply of oil pressures that control the clutches and the brakes of the speed change mechanism 31 based on control signals from the ECU 5. The configuration of the hydraulic control device 4 will be described in detail below.

The ECU 5 includes, e.g., a CPU, a ROM that stores processing programs, a RAM that temporarily stores data, input and output ports, and a communication port and outputs various signals, such as control signals for the hydraulic control device 4, from the output port.

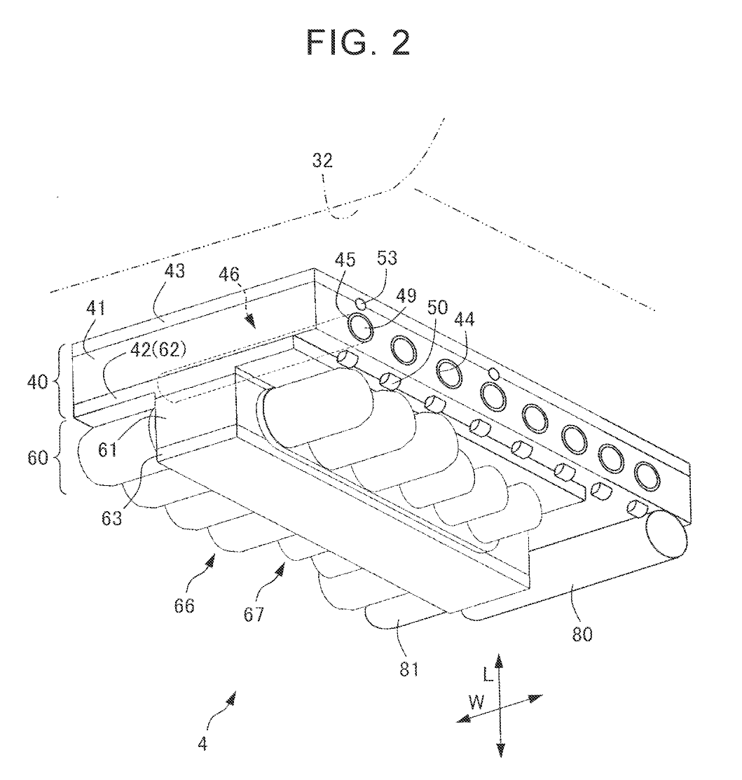

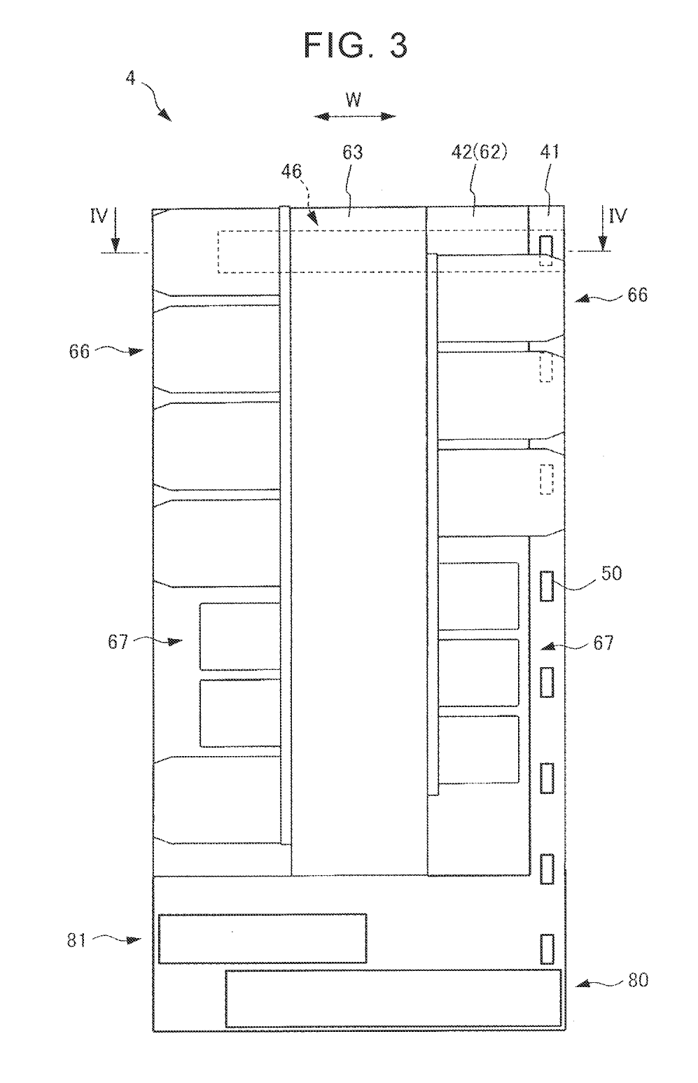

Next, the configuration of the aforementioned hydraulic control device 4 will be described in detail with reference to FIGS. 2 to 5B. As shown in FIGS. 2 and 3, the hydraulic control device 4 is formed by joining a first layer 41, a second layer 42, a third layer 61, a fourth layer 43, and a fifth layer 63, which form a valve body, by, e.g., injection molding using a die slide injection method (hereinafter simply referred to as the DSI method). In the present embodiment, the hydraulic control device 4 includes a valve mounting portion 40 attached to the transmission case 32 and having switch valves (spool valves) 46, and a solenoid mounting portion 60 stacked on the opposite side of the valve mounting portion 40 from the automatic transmission 3 and having linear solenoid valves 66, solenoid valves 67, etc.

The valve mounting portion 40 is formed by stacking three substantially plate-like synthetic resin blocks, namely the first layer 41, a side portion of the second layer 42 which is located on the transmission case 32 side, and the fourth layer 43 and joining the stacked blocks by injection molding. The valve mounting portion 40 is mounted on the automatic transmission 3 and can supply oil pressures to the automatic transmission 3. That is, in the present embodiment, the blocks are stacked and joined by an injection molding material (sealing member).

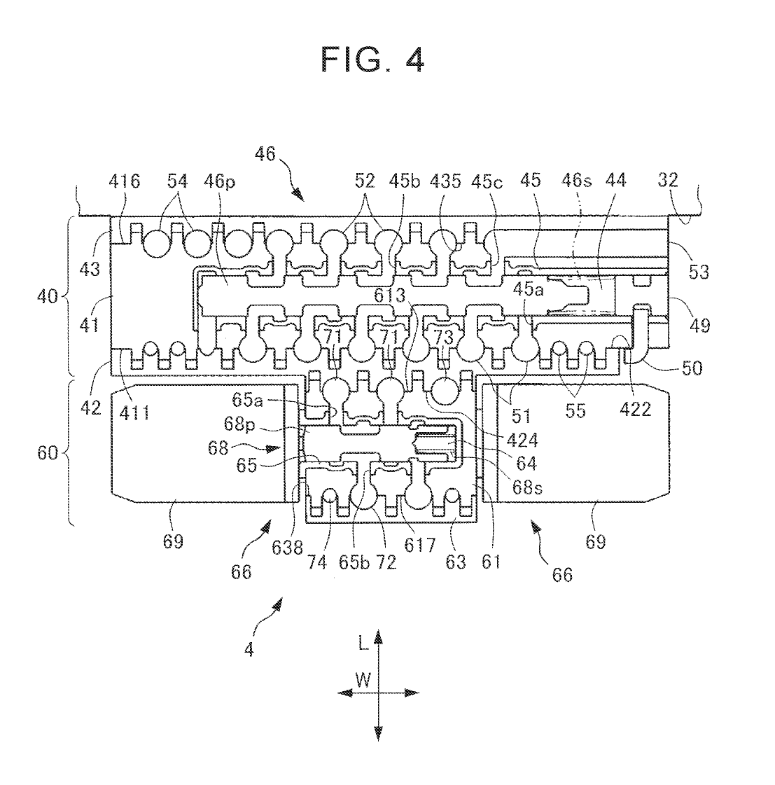

As shown in FIG. 4, the first layer 41 is the middle one of the three layers forming the valve mounting portion 40 and has a plurality of first holes (holes) 44 extending inward from its one side end in a direction perpendicular to the stacking direction L. That is, the first layer 41 has a plurality of first holes 44 extending in a direction perpendicular to the stacking direction L. In the present embodiment, the first layer 41 is formed with bottomed cylindrical metal sleeves 45 insert-molded therein by primary injection molding of the DSI method, and the insides of the sleeves 45 are the first holes 44. In the present embodiment, the lateral direction W is the direction in which the first holes 44 extend.

A switch valve 46, which is a spool valve, is mounted in each sleeve 45. A slidable spool 46p, a biasing spring 46s, which is a compression coil spring that presses the spool 46p in one direction, and a stopper 49 that allows the biasing spring 46s to press the spool 46p are accommodated in each sleeve 45, and these components form a switch valve 46. The stopper 49 is fixed near an opening portion of the sleeve 45 with a fastener 50. Each sleeve 45 has ports 45a, 45b, 45c, which are multiple through holes, in its peripheral side surface. Each port 45a, 45b, 45c is formed along substantially the entire circumference and is closed, except for its opening portion, by the synthetic resin forming the first layer 41. That is, the first layer 41 has a plurality of ports 45a, 45b, 45c of the plurality of switch valves 46 each having a spool 46p accommodated in the first hole 44.

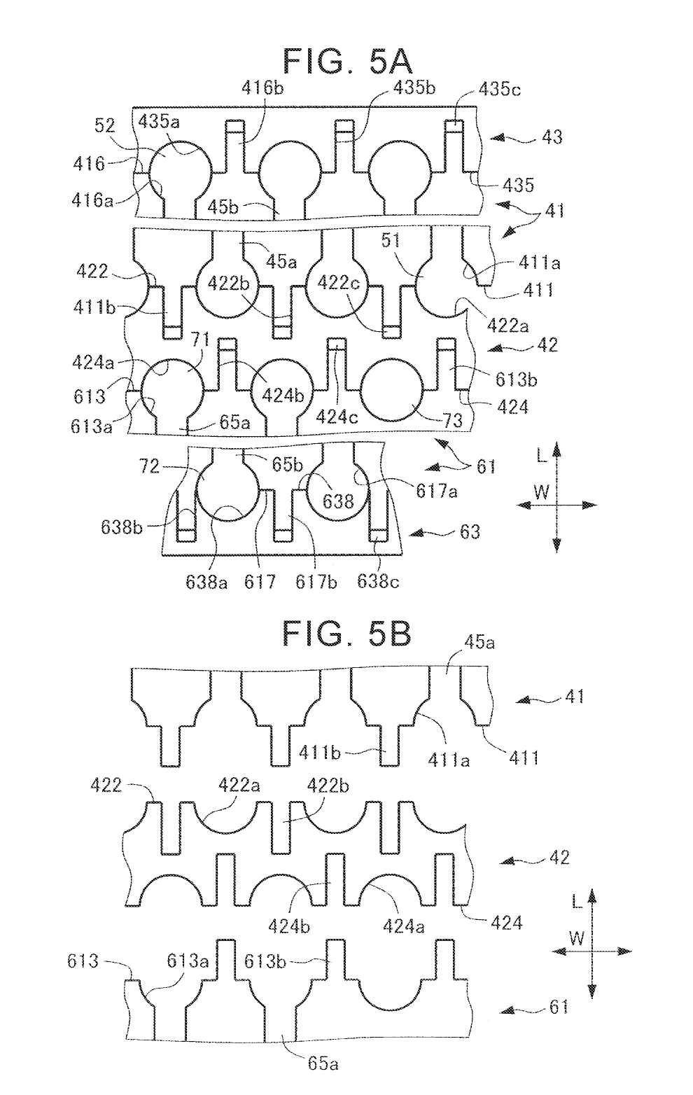

As shown in FIGS. 5A and 5B, the first layer 41 has a first parting surface 411, a plurality of first grooves 411a with a semicircular section, which are formed in the first parting surface 411, and a first protrusion 411b formed on the first parting surface 411. The plurality of first grooves 411a communicate with a part of the plurality of ports 45a, 45b, 45c of the switch valves 46, namely the ports 45a. The first protrusion 411b is formed between adjacent ones of the first grooves 411a on the first parting surface 411 and protrudes toward the second layer 42.

The second layer 42 is stacked on the opposite side of the first layer 41 from the transmission case 32. The second layer 42 has a second parting surface 422, a plurality of second grooves 422a with a semicircular section, which are formed in the second parting surface 422, and a first recess 422b formed in the second parting surface 422. The plurality of second grooves 422a are formed so as to face the plurality of first grooves 411a. The second layer 42 is stacked on the first layer 41 in the stacking direction L with the second parting surface 422 facing the first parting surface 411 of the first layer 41, so that the plurality of first grooves 411a and the plurality of second grooves 422a form a plurality of first oil passages 51. That is, the first oil passages 51 communicate with a part of the plurality of ports 45a, 45b, 45c of the switch valves 46, namely the ports 45a.

The first recess 422b is recessed in the same direction as that in which the first protrusion 411b on the first parting surface 411 protrudes, and the first protrusion 411b is fitted in the first recess 422b with clearance 422c in the stacking direction L. In the present embodiment, the first layer 41 and the second layer 42 are stacked such that the first protrusion 411b is fitted in the first recess 422b between adjacent ones of the first oil passages 51, and an injection molding material is injected into the clearance 422c between the first protrusion 411b and the first recess 422b, whereby the first layer 41 and the second layer 42 are joined by injection molding using the clearance 422c as a cavity. That is, the first layer 41 and the second layer 42 are stacked such that the first protrusion 411b is fitted in the first recess 422b between adjacent ones of the first oil passages 51, and are joined via the first protrusion 411b and the first recess 422b.

The first layer 41 has a sixth parting surface 416 located on the opposite side of the first layer 41 from the first parting surface 411, a plurality of sixth grooves 416a with a semicircular section, which are formed in the sixth parting surface 416, and a protrusion 416b formed on the sixth parting surface 416. The plurality of sixth grooves 416a communicate with a part of the plurality of ports 45a, 45b, 45c of the switch valves 46, namely the ports 45b, 45c. The protrusion 416b is formed between adjacent ones of the sixth grooves 416a on the sixth parting surface 416 and protrudes toward the fourth layer 43.

The fourth layer 43 is stacked on the opposite side of the first layer 41 from the second layer 42 and is attached to the transmission case 32. The fourth layer 43 has a fifth parting surface 435, a plurality of fifth grooves 435a with a semicircular section, which are formed in the fifth parting surface 435, and a recess 435b formed in the fifth parting surface 435. The plurality of fifth grooves 435a are formed so as to face the plurality of sixth grooves 416a. The fourth layer 43 is stacked on the first layer 41 with the fifth parting surface 435 facing the sixth parting surface 416 of the first layer 41, so that the plurality of sixth grooves 416a and the plurality of fifth grooves 435a form a plurality of third oil passages 52. That is, the third oil passages 52 communicate with a part of the plurality of ports 45a, 45b, 45c of the switch valves 46, namely the ports 45b.

The recess 435b is recessed in the same direction as that in which the protrusion 416b on the sixth parting surface 416 protrudes, and the protrusion 416b is fitted in the recess 435b with clearance 435c in the stacking direction L. The first layer 41 and the fourth layer 43 are stacked such that the protrusion 416b is fitted in the recess 435b between adjacent ones of the third oil passages 52, and are joined by injection molding using the clearance 435c between the protrusion 416b and the recess 435b as a cavity.

As shown in FIG. 4, both the oil passages 51 and the oil passages 52 are arranged side by side in the longitudinal direction of the switch valve 46, namely in the lateral direction W. In the present embodiment, regarding the oil passages 51, 52 communicating with the ports 45a, 45b formed in the sleeve 45, the first oil passages 51 formed in the second layer 42 and the third oil passages 52 formed in the fourth layer 43 are alternately arranged along the sleeve 45. That is, at least a part of the first and third oil passages 51, 52 are arranged in a staggered manner on the first parting surface 411 side and the sixth parting surface 416 side with the switch valve 46 interposed therebetween in the stacking direction L. In other words, at least a part of the first and third oil passages 51, 52 are arranged in a staggered manner in the second layer 42 and the fourth layer 43.

The first oil passages 51 formed by the first layer 41 and the second layer 42 communicate with the solenoid mounting portion 60 or allow the ports 45a of the switch valves 46 to communicate with each other. The first oil passages 51 that allow the ports 45a of the switch valves 46 to communicate with each other are formed only by the first layer 41 and the second layer 42 and are not disposed between adjacent ones of the switch valves 46.

The third oil passages 52 formed by the first layer 41 and the fourth layer 43 communicate with the automatic transmission 3 or allow the ports 45b of the switch valves 46 to communicate with each other. The third oil passages 52 that allow the ports 45b of the switch valves 46 to communicate with each other are formed only by the first layer 41 and the fourth layer 43 and are not disposed between adjacent ones of the switch valves 46. That is, the oil passages 51, 52 that allow the ports 45a, 45b of the plurality of switch valves 46, 46 to communicate with each other are formed either between the second layer 42 and the first layer 41 or between the first layer 41 and the fourth layer 43. This restrains an increase in interval between adjacent ones of the switch valves 46 and can prevent an increase in size of the hydraulic control device 4.

For example, in the present embodiment, an oil passage 53 communicating with a part of the ports, namely the port 45c, and extending in the longitudinal direction of the first holes 44 is formed by the first layer 41 and the fourth layer 43. The oil passage 53 is exposed to a side end face of the valve mounting portion 40, and a pipe, not shown, can be attached to the oil passage 53. Moreover, for example, an oil passage 54 that does not communicate with the ports is formed by the first layer 41 and the fourth layer 43, and a signal oil passage 55 etc. that does not communicate with the ports and is thinner than the oil passage 54 is formed by the first layer 41 and the second layer 42. For example, the signal oil passage 55 is used to supply an oil pressure to be detected to a hydraulic sensor etc. The valve mounting portion 40 further has an oil passage, not shown, that extends through the valve mounting portion 40 in the stacking direction L and that allows an oil pressure supplied from the solenoid mounting portion 60 to be supplied as it is to the automatic transmission 3.

The solenoid mounting portion 60 is formed by stacking three substantially plate-like synthetic resin blocks, namely the third layer 61, a side portion of the second layer 42 which is located on the opposite side from the transmission case 32, and the fifth layer 63 and joining the stacked blocks by injection molding. The solenoid mounting portion 60 is stacked on the valve mounting portion 40 and can supply oil pressures to the valve mounting portion 40. That is, in the present embodiment, the blocks are stacked and joined by an injection molding material. In the present embodiment, the second layer 42 is formed by a single member, although the side portion of the second layer 42 which is located on the transmission case 32 side is disposed in the valve mounting portion 40 and the side portion of the second layer 42 which is located on the opposite side from the transmission case 32 is disposed in the solenoid mounting portion 60. However, the second layer 42 is not limited to a single member. The second layer 42 may be formed by separate members joined by injection molding, adhesion, welding, etc.

The third layer 61 is the middle one of the three layers forming the solenoid mounting portion 60 and has a plurality of second holes (holes) 64 extending inward alternately from its one side end and the opposite other side end in a direction perpendicular to the stacking direction L. In the present embodiment, the third layer 61 is formed with bottomed cylindrical metal sleeves 65 insert-molded therein by primary injection molding of the DSI method, and the insides of the sleeves 65 are the second holes 64. In the present embodiment, the lateral direction W is the direction in which the second holes 64 extend.

A linear solenoid valve 66 or a solenoid valve 67 (see FIGS. 2 and 3) is mounted in each sleeve 65. The linear solenoid valve 66 has a pressure regulating portion 68 accommodated in the sleeve 65 and a solenoid portion 69 that drives the pressure regulating portion 68 according to an electrical signal. The pressure regulating portion 68 has a slidable spool 68p that regulates an oil pressure and a biasing spring 68s, which is a compression coil spring that presses the spool 68p in one direction. Each sleeve 65 has ports 65a, 65b, which are multiple through holes, in its peripheral side surface. Each port 65a, 65b is formed along substantially the entire circumference and is closed, except for its opening portion, by the synthetic resin forming the third layer 61. That is, the third layer 61 has a plurality of ports 65a, 65b of the plurality of linear solenoid valves 66.

As shown in FIGS. 5A and 5B, the third layer 61 has a third parting surface 613, a plurality of third grooves 613a with a semicircular section, which are formed in the third parting surface 613, and a second protrusion 613b formed on the third parting surface 613. The plurality of third grooves 613a communicate with a part of the plurality of ports 65a, 65b of the linear solenoid valves 66 or the solenoid valves 67, namely the ports 65a. The second protrusion 613b is formed between adjacent ones of the third grooves 613a on the third parting surface 613 and protrudes toward the second layer 42.

The aforementioned second layer 42 has a fourth parting surface 424 located on the opposite side of the second layer 42 from the second parting surface 422, a plurality of fourth grooves 424a with a semicircular section, which are formed in the fourth parting surface 424, and a second recess 424b formed in the fourth parting surface 424. The plurality of fourth grooves 424a are formed so as to face the plurality of third grooves 613a. The second layer 42 is stacked on the third layer 61 with the fourth parting surface 424 facing the third parting surface 613 of the third layer 61, so that the plurality of third grooves 613a and the plurality of fourth grooves 424a form a plurality of second oil passages 71. That is, the second oil passages 71 communicate with a part of the plurality of ports 65a, 65b of the linear solenoid valves 66 or the solenoid valves 67, namely the ports 65a.

The second recess 424b is recessed in the same direction as that in which the second protrusion 613b on the third parting surface 613 protrudes, and the second protrusion 613b is fitted in the second recess 424b with clearance 424c in the stacking direction L. The third layer 61 and the second layer 42 are stacked such that the second protrusion 613b is fitted in the second recess 424b between adjacent ones of the second oil passages 71, and are joined by injection molding using the clearance 424c between the second protrusion 613b and the second recess 424b as a cavity.

In the second layer 42, the first recess 422b formed in the second parting surface 422 and the second recess 424b formed in the fourth parting surface 424 are arranged in the lateral direction W perpendicular to the stacking direction L so as to be staggered in the stacking direction L. That is, the first recess 422b in the second parting surface 422 and the second recess 424b in the fourth parting surface 424 are arranged in the direction perpendicular to the stacking direction L so as to be staggered in the stacking direction L. Accordingly, unlike in the case where the first recess 422b and the second recess 424b are arranged in the lateral direction W so as to be aligned in the stacking direction L, it is not necessary to increase the thickness of the second layer 42 in order to ensure that there is a sufficient interval between the first recess 422b and the second recess 424b. Accordingly, the thickness of the second layer 42 can be reduced. That is, the second grooves 422a and the fourth grooves 424a are arranged in the direction (lateral direction W) perpendicular to the stacking direction L such that the fourth groove 424a is located between the second grooves 422a.

The third layer 61 has a seventh parting surface 617 located on the opposite side of the third layer 61 from the third parting surface 613, a plurality of seventh grooves 617a with a semicircular section, which are formed in the seventh parting surface 617, and a protrusion 617b formed on the seventh parting surface 617. The plurality of seventh grooves 617a communicate with a part of the plurality of ports 65a, 65b of the linear solenoid valves 66 or the solenoid valves 67, namely the ports 65b. The protrusion 617b is formed between adjacent ones of the seventh grooves 617a on the seventh parting surface 617 and protrudes toward the fifth layer 63.

The fifth layer 63 is stacked on the opposite side of the third layer 61 from the second layer 42. The fifth layer 63 has an eighth parting surface 638, a plurality of eighth grooves 638a with a semicircular section, which are formed in the eighth parting surface 638, and a recess 638b formed in the eighth parting surface 638. The plurality of eighth grooves 638a are formed so as to face the plurality of seventh grooves 617a. The fifth layer 63 is stacked on the third layer 61 with the eighth parting surface 638 facing the seventh parting surface 617 of the third layer 61, so that the plurality of eighth grooves 638a and the plurality of seventh grooves 617a form a plurality of fourth oil passages 72. That is, the fourth oil passages 72 communicate with a part of the plurality of ports 65a, 65b of the linear solenoid valves 66 or the solenoid valves 67, namely the ports 65b.

The recess 638b is recessed in the same direction as that in which the protrusion 617b on the seventh parting surface 617 protrudes, and the protrusion 617b is fitted in the recess 638b with clearance 638c in the stacking direction L. The third layer 61 and the fifth layer 63 are stacked such that the protrusion 617b is fitted in the recess 638b between adjacent ones of the fourth oil passages 72, and are joined by injection molding using the clearance 638c between the protrusion 617b and the recess 638b as a cavity.

As shown in FIG. 4, both the oil passages 71 and the oil passages 72 are arranged side by side in the longitudinal direction of the linear solenoid valve 66 or the solenoid valve 67, namely in the lateral direction W. In the present embodiment, regarding the oil passages 71, 72 communicating with the ports 65a, 65b formed in the sleeve 65, the second oil passages 71 formed in the second layer 42 and the fourth oil passages 72 formed in the fifth layer 63 are alternately arranged along the sleeve 45. That is, at least a part of the second oil passages 71 communicating with a part of the ports, namely the ports 65a, and the fourth oil passages 72 communicating with another part of the ports, namely the ports 65b, are arranged in a staggered manner in the second layer 42 and the fifth layer 63.

The second oil passages 71 formed by the third layer 61 and the second layer 42 communicate with the valve mounting portion 40 or allow the ports 65a of the linear solenoid valves 66 or the ports of the solenoid valves 67 to communicate with each other. The second oil passages 71 that allow the ports 65a of the linear solenoid valves 66 or the ports of the solenoid valves 67 to communicate with each other are formed only by the third layer 61 and the second layer 42 and are not disposed between adjacent ones of the linear solenoid valves 66 and the solenoid valves 67.

The fourth oil passages 72 formed by the third layer 61 and the fifth layer 63 allow the ports 65b of the linear solenoid valves 66 or the ports of the solenoid valves 67 to communicate with each other. The fourth oil passages 72 that allow the ports 65b of the linear solenoid valves 66 or the ports of the solenoid valves 67 to communicate with each other are formed only by the third layer 61 and the fifth layer 63 and are not disposed between adjacent ones of the linear solenoid valves 66 and the solenoid valves 67. That is, the oil passages 71, 72 that allow the ports 65a, 65b of the plurality of linear solenoid valves 66 and solenoid valves 67 to communicate with each other are formed either between the second layer 42 and the third layer 61 or between the third layer 61 and the fifth layer 63. This restrains an increase in interval between adjacent ones of the linear solenoid valves 66 and the solenoid valves 67 and can prevent an increase in size of the hydraulic control device 4.

For example, in the present embodiment, an oil passage 73 that does not communicate with the ports is formed by the third layer 61 and the second layer 42, and a signal oil passage 74 etc. that does not communicate with the ports and is thinner than the oil passage 73 is formed by the third layer 61 and the fifth layer 63.

In the present embodiment, as shown in FIGS. 2 and 3, the solenoid mounting portion 60 has a regulator valve 80 and a modulator valve 81 (source pressure valves) that regulate source pressures to be supplied to the linear solenoid valves 66 and the solenoid valves 67. The regulator valve 80 and the modulator valve 81 are spool valves having a spool and a biasing spring, both not shown, and communicate with the linear solenoid valves 66 and the solenoid valves 67 via the oil passages 71, 72. The regulator valve 80 and the modulator valve 81 regulate an oil pressure supplied from the oil pump, not shown, to generate a line pressure and a modulator pressure, and supplies the line pressure and the modulator pressure to the linear solenoid valves 66 and the solenoid valves 67 as source pressures.

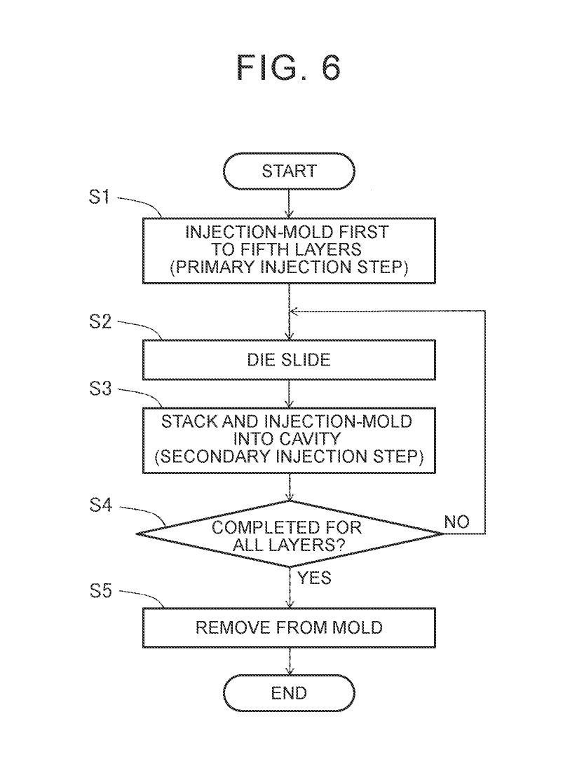

The procedure for a method for manufacturing the aforementioned valve body of the hydraulic control device 4 for the automatic transmission 3 will be described with reference to the flowchart of FIG. 6. In the present embodiment, the valve body of the hydraulic control device 4 is manufactured by the DSI method.

First, each of the first to fifth layers 41 to 63 is formed by injection molding (step S1, primary injection step). At this time, metal sleeves 45, 65 are insert-molded in the first layer 41 and the third layer 61, respectively (see FIG. 4). Opposing dies are moved relative to each other without removing the first to fifth layers 41 to 63 from a mold (step S2). By this die slide operation, a part of the layers are stacked with a protrusion being fitted in a recess, and a synthetic resin is injected into a cavity, whereby the stacked layers are joined by injection molding (step S3, secondary injection step). For example, in the case where the first layer 41 and the second layer 42 are stacked, the first protrusion 411b of the first layer 41 is fitted in the first recess 422b of the second layer 42 and injection molding is performed by using the clearance 422c as a cavity (see FIGS. 5A and 5B).

It is determined if all of the first to fifth layers 41 to 63 have been joined (step S4). If not, the die slide operation is performed again (step S2). If all of the first to fifth layers 41 to 63 have been joined, the resultant valve body is removed from the mold (step S5).

Operation of the aforementioned hydraulic control device 4 for the automatic transmission 3 will be described with reference to FIGS. 1 to 4.

When the oil pump is driven to supply an oil pressure after starting of the internal combustion engine 2, the regulator valve 80 and the modulator valve 81 generate a line pressure and a modulator pressure. The line pressure and the modulator pressure thus generated are supplied to the linear solenoid valves 66 and the solenoid valves 67 via the oil passages 71, 72 in the solenoid mounting portion 60. The linear solenoid valve 66 operates according to an electrical signal from the ECU 5 to generate and output a desired oil pressure based on the line pressure and the modulator pressure. The solenoid valve 67 operates according to an electrical signal from the ECU 5 to supply and cut off supply of an oil pressure based on the line pressure and the modulator pressure.

A part of the oil pressures supplied from the linear solenoid valves 66 and solenoid valves 67 passes through the valve mounting portion 40 via the second oil passages 71 and are supplied to the automatic transmission 3. Another part of the oil pressures supplied from the linear solenoid valves 66 and the solenoid valves 67 passes through the second layer 42 via the second oil passages 71 and the first oil passages 51 and are supplied to the switch valves 46. The positions of the spools 46p of the switch valves 46 are thus switched, or the ports 45a, 45b, 45c are allowed to communicate with each other or communication therebetween is cut off, so that the oil pressures pass through the fourth layer 43 via the third oil passages 52 and are supplied to the automatic transmission 3. The oil pressures are thus supplied to the automatic transmission 3, whereby the clutches, the brakes, etc. of the automatic transmission 3 are engaged or disengaged to establish a desired shift speed or each part of the automatic transmission 3 is lubricated.

As described above, according to the hydraulic control device 4 for the automatic transmission 3 of the present embodiment, as shown in FIGS. 5A and 5B, the first protrusion 411b and the first recess 422b, which are formed in the opposing parting surfaces 411, 422, are fitted together between adjacent ones of the first oil passages 51, and the first layer 41 and the second layer 42 are joined by injection molding using the clearance 422c between the first protrusion 411b and the first recess 422b as a cavity. Such fitting between the first protrusion 411b and the first recess 422b formed in the parting surfaces 411, 422 forms a complex shape between adjacent ones of the first oil passages 51 and thus enhances sealability, as compared to the case where the parting surfaces are flat between adjacent ones of the first oil passages 51. Similarly, enhanced sealability is also achieved for the third oil passages 52 between the first layer 41 and the fourth layer 43, the second oil passages 71 between the third layer 61 and the second layer 42, and the fourth oil passages 72 between the third layer 61 and the fifth layer 63.

The cavity size that achieves similar sealability can thus be made smaller than that required in the case where the parting surfaces are flat between adjacent ones of the oil passages. The pitch between adjacent ones of the oil passages can therefore be reduced. Moreover, the position of the cavity can be shifted in the stacking direction from the parting surfaces as compared to the case where the parting surfaces are flat between adjacent ones of the oil passages and a cavity is provided in the parting surfaces. The pitch between adjacent ones of the oil passages can therefore be reduced. Furthermore, the layers are joined via the first protrusion 411b and the first recess 422b between adjacent ones of the first oil passages 51. This structure provides sufficient strength even with a reduced pitch between adjacent ones of the first oil passages 51 because the layers are joined in thick portions. For these reasons, an increase in size of the valve body is restrained while sufficient sealability between the oil passages and sufficient strength are achieved, as compared to the case where a protrusion and a recess which are fitted together are not formed in opposing parting surfaces in a valve body that is formed by stacking blocks made of a synthetic resin etc.

In the hydraulic control device 4 for the automatic transmission 3 of the present embodiment, the oil passages 51, 52, 71, 72 have a circular section. The distance between the cavity shifted in position in the stacking direction from the parting surface and the oil passage 51, 52, 71, 72 can be increased as compared to the case where the oil passages 51, 52, 71, 72 have a rectangular section. This allows the oil passages 51, 52, 71, 72 to have a sufficient wall thickness, whereby the pitch between adjacent ones of the oil passages 51, 52, 71, 72 can be reduced.

According to the hydraulic control device 4 for the automatic transmission 3 of the present embodiment, in the valve mounting portion 40, at least a part of the oil passages 51 communicating with a part of the ports, namely the ports 45a, and the oil passages 52 communicating with another part of the ports, namely the ports 45b, are arranged in a staggered manner in the second layer 42 and the fourth layer 43. The oil passages 51, 52 communicating with adjacent ports 45a, 45b are therefore not located adjacent to each other. This eliminates the need to increase the pitch between the ports 45a, 45b and thus restrains an increase in overall length of the switch valves 46. An increase in size of the valve body is thus restrained while the valve body is formed by stacking blocks made of a synthetic resin etc.

According to the hydraulic control device 4 for the automatic transmission 3 of the present embodiment, the oil passages that allow the ports 45a, 45b of the switch valves 46 to communicate with each other are formed either between the second layer 42 and the first layer 41 or between the first layer 41 and the fourth layer 43. The oil passages 71, 72 that allow the ports 65a, 65b of the plurality of linear solenoid valves 66 and solenoid valves 67 to communicate with each other are formed either between the second layer 42 and the third layer 61 or between the third layer 61 and the fifth layer 63. This restrains an increase in interval between adjoining ones of the various valves 46, 66, 67 and can prevent an increase in size of the hydraulic control device 4.

The aforementioned hydraulic control device 4 for the automatic transmission 3 of the present embodiment is described with respect to the case where the valve mounting portion 40 is attached to the transmission case 32 and the solenoid mounting portion 60 is stacked on the opposite side of the valve mounting portion 40 from the automatic transmission 3. However, the present disclosure is not limited to this. For example, the solenoid mounting portion 60 may be mounted on the transmission case 32 of the automatic transmission 3 so that the solenoid mounting portion 60 can supply oil pressures to the automatic transmission 3, and the valve mounting portion 40 may be mounted on the opposite side of the solenoid mounting portion 60 from the automatic transmission 3.

The automatic transmission 3 of the present embodiment is described with respect to the case where all of the first to fifth layers 41 to 63 are made of a synthetic resin. However, the present disclosure is not limited to this, and at least a part of the layers may be made of a metal such as, e.g., aluminum die cast.

In the hydraulic control device 4 for the automatic transmission 3 of the present embodiment, the oil passages 51, 52, 71, 72 have a circular section. However, the present disclosure is not limited to this, and the oil passages 51, 52, 71, 72 may have a rectangular section.

In the hydraulic control device 4 for the automatic transmission 3 of the present embodiment, the first protrusion 411b is formed on the first parting surface 411 and the first recess 422b is formed in the second parting surface 422 so that the first protrusion 411b is fitted in the first recess 422b. However, the direction in which the protrusion protrudes and the recess is recessed is not limited to this. For example, a recess may be formed in the first parting surface 411 and a protrusion may be formed on the second parting surface 422 so that the protrusion is fitted in the recess. Similarly, regarding fitting between the second protrusion 613b on the third parting surface 613 and the second recess 424b in the fourth parting surface 424, fitting between the recess 435b in the fifth parting surface 435 and the protrusion 416b on the sixth parting surface 416, and fitting between the protrusion 617b on the seventh parting surface 617 and the recess 638b in the eighth parting surface 638, the direction in which the protrusion protrudes and the recess is recessed may be opposite.

In the hydraulic control device 4 for the automatic transmission 3 of present embodiment, the sealing member that joins the stacked blocks is an injection molding material. However, the present disclosure is not limited to this. For example, the sealing member may be an adhesive. That is, the first protrusion 411b and the first recess 422b may be joined by adhesion. In this case, the valve body can be assembled at low cost.

The present embodiment includes at least the following configuration. A hydraulic control device (4) for an automatic transmission (3) according to the present embodiment includes: a first layer (41) having a first parting surface (411) and a plurality of first grooves (411a) formed in the first parting surface (411); and a second layer (42) that has a second parting surface (422) and a plurality of second grooves (422a) formed in the second parting surface (422) and facing the plurality of first grooves (411a), and that is stacked on the first layer (41) in a stacking direction (L) with the second parting surface (422) facing the first parting surface (411) of the first layer (41), so that the plurality of first grooves (411a) and the plurality of second grooves (422a) form a plurality of first oil passages (51). A first protrusion (411b) is formed between adjacent ones of the grooves (411a) on the parting surface (411) of one (41) of the first layer (41) and the second layer (42) so as to protrude toward the other layer (42), a first recess (422b) in which the first protrusion (411b) is fitted with clearance (422c) in the stacking direction (L) is formed in the parting surface (422) of the other layer (42), and the first layer (41) and the second layer (42) are stacked such that the first protrusion (411b) is fitted in the first recess (422b) between adjacent ones of the first oil passages (51), and are joined via the first protrusion (411b) and the first recess (422b). According to this configuration, the first layer (41) and the second layer (42) are stacked such that the first protrusion (411b) is fitted in the first recess (422b) between adjacent ones of the first oil passages (51), and are joined via the first protrusion (411b) and the first recess (422b). Such fitting between the first protrusion (411b) and the first recess (422b) formed in the parting surfaces (411, 422) forms a complex shape between adjacent ones of the first oil passages (51) and thus enhances sealability, as compared to the case where the parting surfaces are flat between adjacent ones of the first oil passages (51). The width of a sealing portion which achieves similar sealability can thus be made smaller than that of a sealing portion which is required in the case where the parting surfaces are flat between adjacent ones of the first oil passages (51). The pitch between adjacent ones of the first oil passages (51) can therefore be reduced. Moreover, the first layer (41) and the second layer (42) are joined via the first protrusion (411b) and the first recess (422b) between adjacent ones of the first oil passages (51). This structure provides sufficient strength even with a reduced pitch between adjacent ones of the first oil passages (51) because the first layer (41) and the second layer (42) are joined in thick portions. An increase in size of a valve body that is formed by stacking blocks made of a synthetic resin etc. is thus restrained while sufficient sealability between the first oil passages (51) and sufficient strength are achieved, as compared to the case where a protrusion and a recess which are fitted together are not formed in opposing parting surfaces.

In the hydraulic control device (4) for the automatic transmission (3) according to the present embodiment, a distal end of the first protrusion (411b) has a rectangular section, a bottom of the first recess (422b) has a rectangular section, and the first protrusion (411b) is fitted in the first recess (422b) so that clearance (422c) with a rectangular section is formed therebetween. According to this configuration, a sealing member or an adhesive is injected into the clearance (422c). This further improves sealability and strength because the sealing member or the adhesive can be injected extensively and effectively.

In the hydraulic control device (4) for the automatic transmission (3) according to the present embodiment, the first protrusion (411b) is formed on the first layer (41), the first recess (422b) is formed in the second layer (42), and the second grooves (422a) have a semicircular section. According to this configuration, since the second grooves (422a) have a semicircular section, an increase in size of the valve body can be more effectively restrained by shifting the fitting position, the position where the protrusion (411b) and the first recess (422b) are fitted together between the second grooves (422a), in the stacking direction with respect to the second grooves (422a), as compared to the case where the second grooves (422a) have a rectangular section.

In the hydraulic control device (4) for the automatic transmission (3) according to the present embodiment, clearance (422c) is provided between the first protrusion (411b) and the first recess (422b), and the sealing member is injected into the clearance (422c) to join the first protrusion (411b) and the first recess (422b). According to this configuration, the use of the clearance (422c) allows the sealing member to be injected extensively and effectively, which further improves sealability and strength.

In the hydraulic control device (4) for the automatic transmission (3) according to the present embodiment, the sealing member is an injection molding material, and the injection molding material is injected into the clearance (422c) serving as a cavity to join the first protrusion (411b) and the first recess (422b) by injection molding. According to this configuration, an injection molding method is used to produce the hydraulic control device (4) that is formed by stacking blocks. Accordingly, the hydraulic control device (4) can be more accurately and easily produced as compared to the case where other manufacturing methods are used.

In the hydraulic control device (4) for the automatic transmission (3) according to the present embodiment, each of the first layer (41) and the second layer (42) is formed by primary injection molding, and the first layer (41) and the second layer (42) are joined by secondary injection molding using the clearance (422c) as a cavity. According to this configuration, the hydraulic control device (4) is produced by a DSI method. Accordingly, a hollow structure such as oil passages (51, 52, 71, 72) can be formed accurately.

In the hydraulic control device (4) for the automatic transmission (3) according to the present embodiment, the first protrusion (411b) and the first recess (422b) are joined by adhesion. According to this configuration, blocks can be easily stacked at low cost with improved sealability and strength by using an adhesive.

The hydraulic control device (4) for the automatic transmission (3) according to the present embodiment further includes: a third layer (61) having a third parting surface (613) and a plurality of third grooves (613a) formed in the third parting surface (613). The second layer (42) further has a fourth parting surface (424) located on the opposite side of the second layer (42) from the second parting surface (424), and a plurality of fourth grooves (424a) formed in the fourth parting surface (424) and facing the plurality of third grooves (613a), a second protrusion (613b) is formed between adjacent ones of the grooves (613a) on the parting surface (613) of one (61) of the second layer (42) and the third layer (61) so as to protrude toward the other layer (42), a second recess (424b) in which the second protrusion (613b) is fitted is formed in the parting surface (424) of the other layer (42), and the second layer (42) and the third layer (61) are stacked such that the second protrusion (613b) is fitted in the second recess (424b) between adjacent ones of the second oil passages (71), and are joined via the second protrusion (613b) and the second recess (424b). According to this configuration, even in the case where the second layer (42) having parting surfaces (422, 424) on both sides is used, the pitch between the oil passages (51, 71) can be reduced by arranging the first oil passages (51) and the second oil passages (71) in a staggered manner in both parting surfaces (422, 424). This restrains an increase in size of the valve body.

In the hydraulic control device (4) for the automatic transmission (3) according to the present embodiment, the second protrusion (613b) is formed on the third layer (61), the second recess (424b) is formed in the second layer (42), and the fourth grooves (424a) have a semicircular section. According to this configuration, since the second grooves (422a) have a semicircular section, an increase in size of the valve body can be more effectively restrained by shifting the fitting position, the position where the protrusion (411b) and the first recess (422b) are fitted together between the second grooves (422a), in the stacking direction with respect to the second grooves (422a), as compared to the case where the second grooves (422a) have a rectangular section.

In the hydraulic control device (4) for the automatic transmission (3) according to the present embodiment, the first protrusion (411b) is formed on the first layer (41), the first recess (422b) is formed in the second layer (42), the second grooves (422a) have a semicircular section, the second protrusion (613b) is formed on the third layer (61), the second recess (424b) is formed in the second layer (42), and the fourth grooves (424a) have a semicircular section, and the second grooves (422a) and the fourth grooves (424a) are arranged in a direction (W) perpendicular to the stacking direction (L) such that the fourth groove (424a) is located between the second grooves (422a). According to this configuration, unlike in the case where the second grooves (422a) and the fourth grooves (424a) are arranged so as to be aligned in the stacking direction (L), it is not necessary to increase the thickness of the second layer (42) in order to ensure that there is a sufficient interval between the grooves (422a, 424a). Accordingly, the thickness of the second layer (42) can be reduced, whereby an increase in size of the valve body can be restrained.

A method for manufacturing a hydraulic control device (4) for an automatic transmission (3) according to the present embodiment includes: a primary injection step of injection-molding each of a first layer (41) that has a first parting surface (411), a plurality of first grooves (411a) formed in the first parting surface (411), and a protrusion (411b) or a recess formed between adjacent ones of the first grooves (411a) in the first parting surface (411) and a second layer (42) that has a second parting surface (422), a plurality of second grooves (422a) formed in the second parting surface (422) and facing the plurality of first grooves (411a), and a recess (422b) or a protrusion formed in the second parting surface (422) so as to be fitted with the protrusion (411b) or the recess of the first layer (41) with clearance (422c) in a stacking direction (L); and a secondary injection step of stacking the first layer (41) and the second layer (42) such that the protrusion (411b) is fitted in the recess (422b), and joining the first layer (41) and the second layer (42) by secondary injection molding using the clearance (422c) as a cavity. According to this configuration, the hydraulic control device (4) is produced by a DSI method. Accordingly, a hollow structure such as oil passages (51, 52, 71, 72) can be formed accurately.

### Second Embodiment

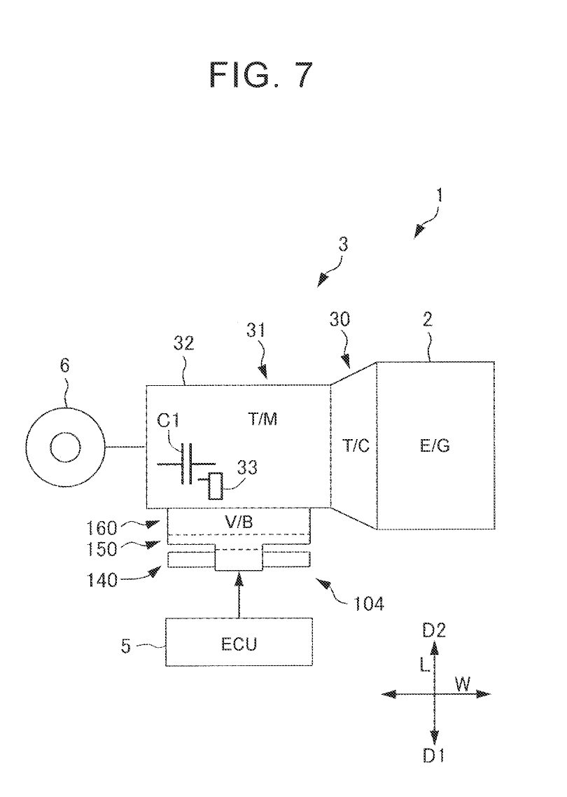

A second embodiment of the present disclosure will be described in detail with reference to FIGS. 7 to 14. The present embodiment is different in configuration from the first embodiment in that a hydraulic control device 104 is formed by stacking a solenoid mounting portion 140, a valve mounting portion 160, and an oil passage mounting portion 150 interposed between the solenoid mounting portion 140 and the valve mounting portion 160. Configurations similar to those of the first embodiment are denoted with the same reference characters and detailed description thereof will be omitted.

First, the general configuration of a vehicle 1 on which an automatic transmission 3 of the present embodiment is mounted will be described with reference to FIG. 7. An automatic transmission 3 similar to the automatic transmission 3 of the first embodiment is applied to the present embodiment (see FIG. 1). In the automatic transmission 3 of the present embodiment, a speed change mechanism 31 is a multi-speed speed change mechanism that can establish a plurality of shift speeds by engagement and disengagement of a plurality of clutches and brakes including a first clutch (friction engagement element) C1. The speed change mechanism 31 has a hydraulic servo 33 that can engage and disengage the first clutch C1 by supplying and cutting off supply of an oil pressure.

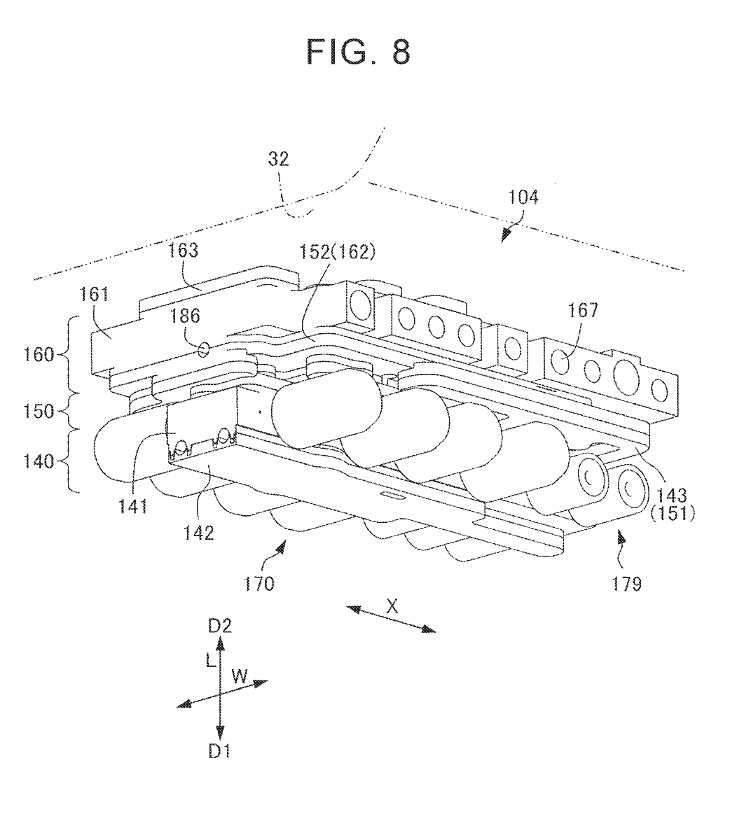

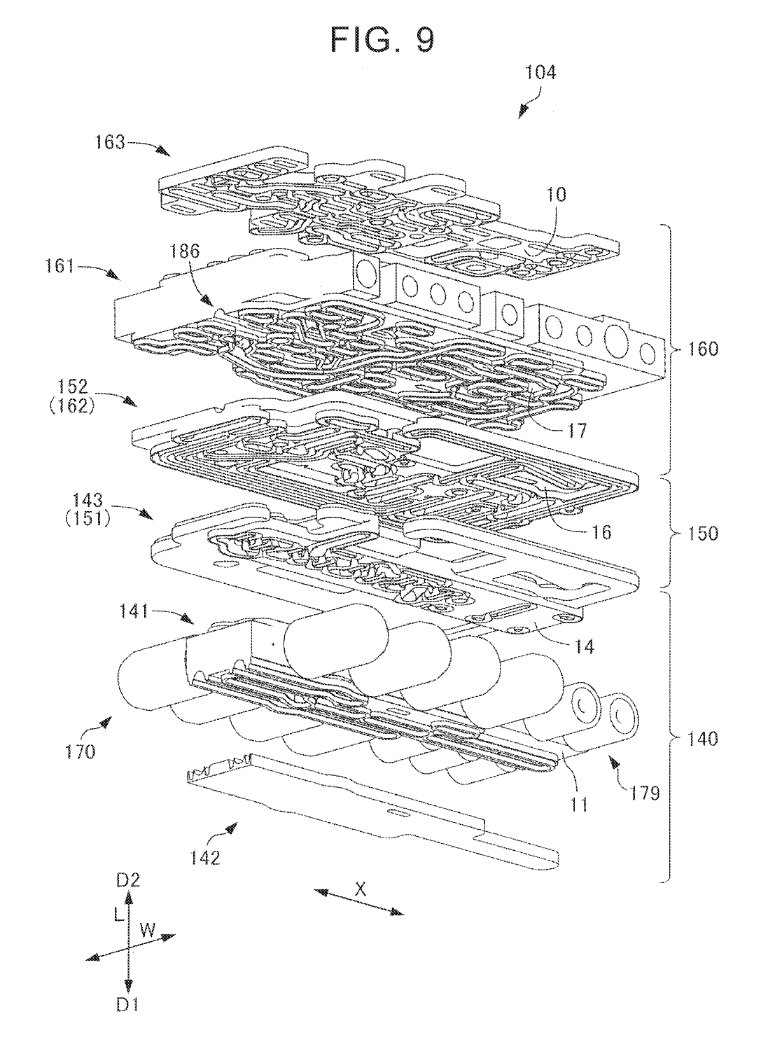

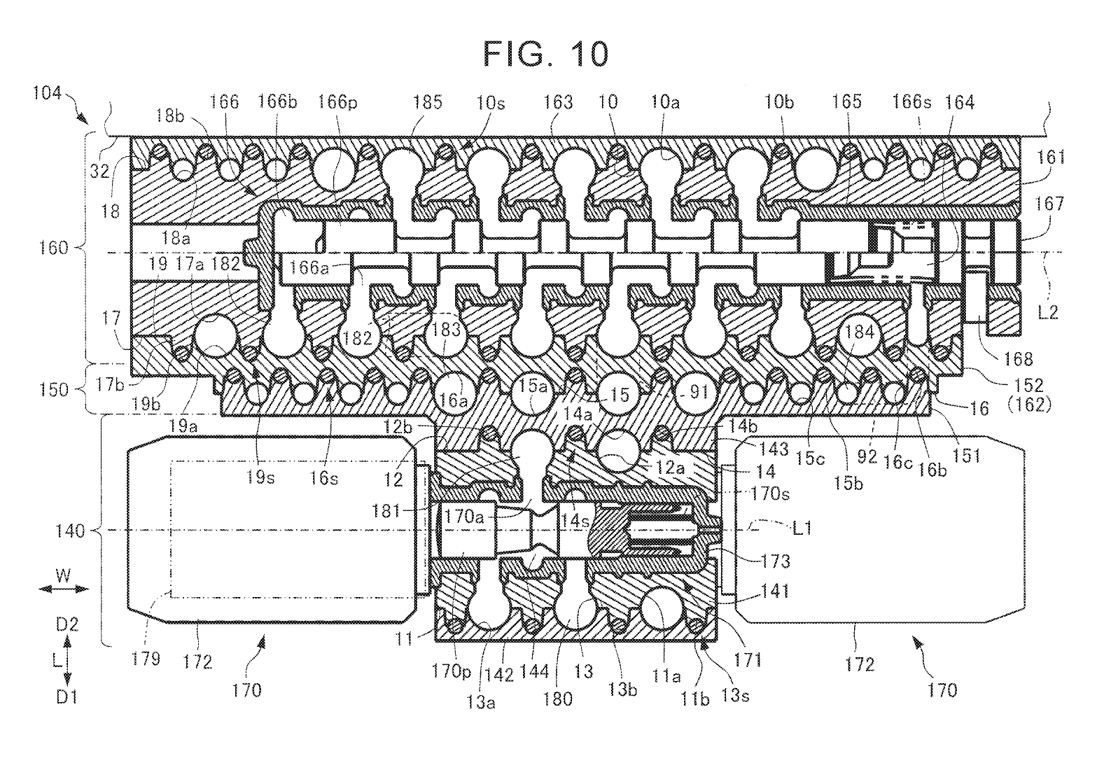

The configuration of the hydraulic control device 104 will be described in detail with reference to FIGS. 8 to 10. As shown in FIGS. 8 and 9, the hydraulic control device 104 is a valve body and is formed by stacking the solenoid mounting portion 140 accommodating pressure regulating portions 171 of linear solenoid valves 170 and solenoid valves 179, the valve mounting portion 160 accommodating valves such as switch valves 166 (see FIG. 10), and the oil passage mounting portion 150 interposed between the solenoid mounting portion 140 and the valve mounting portion 160.

In the present embodiment, the stacking direction L is the vertical direction, and the valve mounting portion 160 is attached to a transmission case 32 with the solenoid mounting portion 140 facing downward (first direction D1) and the valve mounting portion 160 facing upward (second direction D2). That is, of the stacking direction L, the direction from the oil passage mounting portion 150 toward the solenoid mounting portion 140 is the first direction D1, and the opposite direction is the second direction D2. The lateral direction W is the longitudinal direction of the central axis L1 (see FIG. 10) of the linear solenoid valve 170 described later.

As shown in FIGS. 8 to 10, the solenoid mounting portion 140 has three substantially plate-like synthetic resin blocks, namely a first block 141, a second block 142, and a third block 143 and is formed by stacking these three layers and joining the stacked layers by, e.g., injection molding.

The first block 141 is the middle one of the three layers forming the solenoid mounting portion 140 and has a plurality of holes 144 extending inward alternately from its one side end and the opposite other side end in the lateral direction W perpendicular to the stacking direction L. In the present embodiment, the first block 141 is formed with bottomed cylindrical metal sleeves 173 insert-molded therein by primary injection molding of the DSI method, and the insides of the sleeves 173 are the holes 144. The central axis L1 of each sleeve 173 is parallel to the lateral direction W.

A linear solenoid valve 170 or a solenoid valve 179 is mounted in each sleeve 173. The linear solenoid valves 170 and the solenoid valves 179 are mounted with their central axes being parallel and on the same plane. The linear solenoid valve 170 has a pressure regulating portion 171 that is accommodated in the sleeve 173 and regulates an oil pressure by a spool 170p, and a solenoid portion 172 that drives the pressure regulating portion 171 according to an electrical signal. The pressure regulating portion 171 has a slidable spool 170p that regulates an oil pressure and a biasing spring 170s, which is a compression coil spring that presses the spool 170p in one direction.

Each sleeve 173 has port portions 170a, which have a multiplicity of through holes, in its peripheral side surface. Each port portion 170a has a port formed in the inner peripheral surface of the sleeve 173, a communication hole extending from the port and communicating with the outer periphery of the sleeve 173, and an opening portion that allows the communication hole to open in the outer peripheral surface of the sleeve 173. Each port portion 170a is closed, in its opening portion, by the synthetic resin forming the first block 141. The linear solenoid valve 170 can supply an oil pressure to, e.g., the hydraulic servo 33 that can engage and disengage the first clutch C1, etc. In the present embodiment, the port portions 170a are disposed so that the linear solenoid valve 170 receives an oil pressure from the second block 142 side and outputs an oil pressure from the third block 143 side. However, it should be understood that the present disclosure is not limited to this.

In the present embodiment, the linear solenoid valves 170 generate an output pressure according to an electrical signal based on a received oil pressure. The solenoid valves 179 are on-off solenoid valves that supply and cut off supply of an output pressure according to an electrical signal. The linear solenoid valves 170 and the solenoid valves 179 are disposed adjacent and parallel to each other in a direction crossing, e.g., perpendicular to, the stacking direction L.

The first block 141 has a first surface 11 facing the first direction D1, a plurality of grooves 11a with a semicircular section, which are formed in the first surface 11, and a protrusion 11b formed on the first surface 11. The plurality of grooves 11a communicate with a part of a plurality of port portions of the linear solenoid valves 170 or the solenoid valves 179, namely the port portions 170a. The protrusion 11b protrudes toward the second block 142. The first block 141 further has a second surface 12 facing the second direction D2, a plurality of grooves 12a with a semicircular section, which are formed in the second surface 12, and a protrusion 12b formed on the second surface 12. The plurality of grooves 12a communicate with a part of the plurality of port portions of the linear solenoid valves 170 or the solenoid valves 179, namely the port portions 170a. The protrusion 12b protrudes toward the third block 143. Moreover, the first block 141 has the plurality of holes 144 formed between the first surface 11 and the second surface 12 so as to extend along the first surface 11 and the second surface 12 and accommodating the pressure regulating portions 171.

The second block 142 has a third surface 13 facing the first surface 11 of the first block 141, a plurality of grooves 13a with a semicircular section, which are formed in the third surface 13, and a recess 13b formed in the third surface 13. The plurality of grooves 13a are formed so as to face the plurality of grooves 11a. The second block 142 is stacked on the first block 141 with the third surface 13 facing the first surface 11 of the first block 141, so that the plurality of grooves 11a and the plurality of grooves 13a form a plurality of oil passages 180. The recess 13b is recessed in the same direction as that in which the protrusion 11b on the first surface 11 protrudes, and the protrusion 11b is fitted in the recess 13b with clearance in the stacking direction L. The first block 141 and the second block 142 are stacked such that the protrusion 11b is fitted in the recess 13b between adjacent ones of the oil passages 180, and are joined by injection molding using clearance 13s between the protrusion 11b and the recess 13b as a cavity.

The third block 143 is stacked on the opposite side of the first block 141 from the second block 142. The third block 143 has a fourth surface 14 facing the second surface 12 of the first block 141, a plurality of grooves 14a with a semicircular section, which are formed in the fourth surface 14, and a recess 14b formed in the fourth surface 14. The plurality of grooves 14a are formed so as to face the plurality of grooves 12a. The third block 143 is stacked on the first block 141 with the fourth surface 14 facing the second surface 12 of the first block 141, so that the plurality of grooves 12a and the plurality of grooves 14a form a plurality of oil passages 181. The recess 14b is recessed in the same direction as that in which the protrusion 12b on the second surface 12 protrudes, and the protrusion 12b is fitted in the recess 14b with clearance in the stacking direction L. The first block 141 and the third block 143 are stacked such that the protrusion 12b is fitted in the recess 14b between adjacent ones of the oil passages 181, and are joined by injection molding using clearance 14s between the protrusion 12b and the recess 14b as a cavity.

The oil passages 181 formed by the first block 141 and the third block 143 communicate with the valve mounting portion 160 via the oil passage mounting portion 150 or allow the port portions 170a of the linear solenoid valves 170 or the port portions of the solenoid valves 179 to communicate with each other. The oil passages 180 formed by the first block 141 and the second block 142 allow the port portions 170a of the linear solenoid valves 170 or the port portions of the solenoid valves 179 to communicate with each other. The oil passages 180 also communicate with various source pressure supply portions to supply source pressures such as a line pressure and a modulator pressure to the linear solenoid valves 170 and the solenoid valves 179.

The oil passage mounting portion 150 has two substantially plate-like synthetic resin blocks, namely a fourth block (first layer) 151 and a fifth block (second layer) 152, and is formed by stacking these two layers and joining the stacked layers by, e.g., injection molding. In the present embodiment, the fourth block 151 is disposed on the side of the third block 143 which faces the second direction D2, and the fourth block 151 and the third block 143 are formed by a single member. However, the fourth block 151 and the third block 143 are not limited to a single member. The fourth block 151 and the third block 143 may be formed by separate members joined by injection molding, adhesion, welding, etc.

The fourth block 151 has a fifth surface (first parting surface) 15 facing the second direction D2, a plurality of large diameter grooves (first grooves) 15a and a plurality of small diameter grooves (first grooves) 15c with a semicircular section, which are formed in the fifth surface 15, and a first protrusion 15b formed on the fifth surface 15. The first protrusion 15b protrudes in the second direction D2 and is formed on the fifth surface 15 so as to surround the plurality of grooves 15a, 15c.

The fifth block 152 has a sixth surface (second parting surface) 16 disposed so as to face the fifth surface 15 of the fourth block 151, a plurality of large diameter grooves (second grooves) 16a and a plurality of small diameter grooves (second grooves) 16c with a semicircular section, which are formed in the sixth surface 16, and a first recess 16b formed in the sixth surface 16. The plurality of large diameter grooves 16a are formed so as to face the plurality of large diameter grooves 15a. The plurality of small diameter grooves 16c are formed so as to face the plurality of small diameter grooves 15c. The fifth block 152 is stacked on the fourth block 151 with the sixth surface 16 facing the fifth surface 15 of the fourth block 151, so that the plurality of large diameter grooves 16a and the plurality of large diameter grooves 15a form a plurality of large diameter oil passages (first oil passages) 183 and the plurality of small diameter grooves 16c and the plurality of small diameter grooves 15c form a plurality of small diameter oil passages (first oil passages) 184. The first recess 16b is recessed in the same direction as that in which the first protrusion 15b on the fifth surface 15 protrudes, and the first protrusion 15b is fitted in the first recess 16b with clearance in the stacking direction L. That is, the first recess 16b is formed in the sixth surface 16 so as to surround the plurality of grooves 16a, 16c. The fourth block 151 and the fifth block 152 are stacked such that the first protrusion 15b is fitted in the first recess 16b between adjacent ones of the oil passages 183, 184, and are joined by injection molding using clearance 16s between the first protrusion 15b and the first recess 16b as a cavity.

In the present embodiment, the height of the first protrusion 15b is smaller than the depth of the first recess 16b, the space between the distal end face of the first protrusion 15b and the bottom surface of the first recess 16b is filled with a sealing member, so that the first protrusion 15b and the first recess 16b are bonded together by the sealing member SL. The sealing member SL is an injection molding material and the first protrusion 15b and the first recess 16b are bonded together by injection molding. The bonded portion between the first protrusion 15b and the first recess 16b will be described in detail later.

The direction in which the large diameter oil passages 183 and the small diameter oil passages 184 extend, namely the direction crossing the stacking direction L, includes a direction perpendicular to the stacking direction L and a direction tilted with respect to the stacking direction L. The oil passages 183, 184 may have a portion extending in the stacking direction L. In the present embodiment, the large diameter oil passages 183 and the small diameter oil passages 184 have a substantially circular section.

Regarding the sectional shape of the oil passages 183, 184, the substantially circular shape includes, in addition to a perfect circle, a continuously curved shape such as an ellipse.

The large diameter oil passages 183 communicate with a communication oil passage 91 formed in at least one of the fourth block 151 and the fifth block 152. The small diameter oil passages 184 communicate with a small diameter communication oil passage 92 formed in at least one of the fourth block 151 and the fifth block 152. For example, the oil passages 183, 184 allow hydraulic oil to flow between the fourth block 151 and the fifth block 152, or from the fourth block 151 to the fourth block 151 or from the fifth block 152 to the fifth block 152. For example, the oil passages 183, 184 allow two of the hydraulic servo 33 for the first clutch C1, the port portions 170a of the linear solenoid valves 170, and port portions 166a of the switch valves 166 to communicate with each other. For example, in the present embodiment, the large diameter oil passages 183 are used to cause high flow rate hydraulic oil, such as a line pressure, a range pressure, and an oil pressure that controls a friction engagement element, to pass therethrough. For example, the small diameter oil passages 184 are used to cause low flow rate hydraulic oil, such as a signal pressure for the switch valve 166, to flow therethrough.

The valve mounting portion 160 has three substantially plate-like synthetic resin blocks, namely a sixth block (third layer) 161, a seventh block (second layer) 162, and an eighth block 163, and is formed by stacking these three layers and joining the stacked layers by, e.g., injection molding. The valve mounting portion 160 is stacked on the opposite side of the oil passage mounting portion 150 from the solenoid mounting portion 140 in the stacking direction L and accommodates the switch valves 166. In the present embodiment, the sixth block 161 is disposed on the side of the seventh block 162 which faces the second direction D2.

The sixth block 161 is the middle one of the three layers forming the valve mounting portion 160 and has a plurality of holes 164 extending inward from its one side end and the opposite other side end in the lateral direction W perpendicular to the stacking direction L. In the present embodiment, the sixth block 161 is formed with bottomed cylindrical metal sleeves 165 insert-molded therein by primary injection molding of the DSI method, and the insides of the sleeves 165 are the holes 164. The central axis L2 of each sleeve 165 is parallel to the lateral direction W.

A switch valve 166, which is a spool valve, is mounted in each sleeve 165. A slidable spool 166p, a biasing spring 166s, which is a compression coil spring that presses the spool 166p in one direction, and a stopper 167 that allows the biasing spring 166s to press the spool 166p are accommodated in each sleeve 165, and these components form a switch valve 166. The stopper 167 is fixed near an opening portion of the sleeve 165 by a fastener 168. Each sleeve 165 has port portions 166a, which are multiple through holes, in its peripheral side surface. Each port portion 166a has a port formed in the inner peripheral surface of the sleeve 165, a communication hole extending from the port and communicating with the outer periphery of the sleeve 165, and an opening portion that allows the communication hole to open in the outer peripheral surface of the sleeve 165. Each port portion 166a is closed, in its opening portion, by the synthetic resin forming the sixth block 161. For example, the switch valve 166 can switch oil passages or regulate an oil pressure. The switch valve 166 that can switch oil passages is a spool valve having the movable spool 166p, the biasing spring 166s that presses the spool 166p in one direction, and a hydraulic oil chamber 166b that moves the spool 166p in a direction against the biasing spring 166s by a received oil pressure.

The sixth block 161 has a seventh surface (third parting surface) 17, a plurality of third grooves 17a with a semicircular section, which are formed in the seventh surface 17, and a second protrusion 17b formed on the seventh surface 17. The plurality of third grooves 17a communicate with a part of a plurality of port portions of the switch valves 166, namely the port portions 166a. The second protrusion 17b is formed between adjacent ones of the third grooves 17a on the seventh surface 17 and protrudes toward the seventh block 162. The sixth block 161 further has an eighth surface 18 located on the opposite side of the sixth block 161 from the seventh surface 17, a plurality of grooves 18a with a semicircular section, which are formed in the eighth surface 18, and a protrusion 18b formed on the eighth surface 18. The plurality of grooves 18a communicate with a part of the plurality of port portions of the switch valves 166, namely the port portions 166a. The protrusion 18b is formed between adjacent ones of the grooves 18a on the eighth surface 18 and protrudes toward the eighth block 163. The sixth block 161 further has the plurality of holes 164 formed between the seventh surface 17 and the eighth surface 18 so as to extend along the seventh surface 17 and the eighth surface 18 and accommodating the switch valves 166.

The seventh block 162 is stacked on the opposite side of the sixth block 161 from the transmission case 32. In the present embodiment, the seventh block 162 is disposed on the side of the fifth block 152 which faces the second direction D2, and the seventh block 162 and the fifth block 152 are formed by a single member. However, the seventh block 162 and the fifth block 152 are not limited to a single member. The seventh block 162 and the fifth block 152 may be formed by separate members joined by injection molding, adhesion, welding, etc.

The seventh block 162 has a ninth surface (fourth parting surface) 19, a plurality of fourth grooves 19a with a semicircular section, which are formed in the ninth surface 19, and a second recess 19b formed in the ninth surface 19. The plurality of fourth grooves 19a are formed so as to face the plurality of third grooves 17a. The seventh block 162 is stacked on the sixth block 161 in the stacking direction L with the ninth surface 19 facing the seventh surface 17 of the sixth block 161, so that the plurality of third grooves 17a and the plurality of fourth grooves 19a form a plurality of second oil passages 182. The oil passages 183, 184 communicate with the second oil passages 182 in a direction crossing, e.g., perpendicular to, opposing surfaces such as the seventh surface 17 and the ninth surface 19.

The second recess 19b is recessed in the same direction as that in which the second protrusion 17b on the seventh surface 17 protrudes, and the second protrusion 17b is fitted in the second recess 19b with clearance in the stacking direction L. In the present embodiment, the sixth block 161 and the seventh block 162 are stacked such that the second protrusion 17b is fitted in the second recess 19b between adjacent ones of the second oil passages 182, and an injection molding material is injected into clearance 19s between the second protrusion 17b and the second recess 19b, whereby the sixth block 161 and the seventh block 162 are joined by injection molding using the clearance 19s as a cavity.

The eighth block 163 is stacked on the opposite side of the sixth block 161 from the seventh block 162 and is attached to the transmission case 32. The eighth block 163 has a tenth surface 10, a plurality of grooves 10a with a semicircular section, which are formed in the tenth surface 10, and a recess 10b formed in the tenth surface 10. The plurality of grooves 10a are formed so as to face the plurality of grooves 18a. The eighth block 163 is stacked on the sixth block 161 with the tenth surface 10 facing the eighth surface 18 of the sixth block 161, so that the plurality of grooves 10a and the plurality of grooves 18a form a plurality of oil passages 185.

The recess 10b is recessed in the same direction as that in which the protrusion 18b on the eighth surface 18 protrudes, and the protrusion 18b is fitted in the recess 10b with clearance in the stacking direction L. The sixth block 161 and the eighth block 163 are stacked such that the protrusion 18b is fitted in the recess 10b between adjacent ones of the oil passages 185, and are joined by injection molding using clearance 10s between the protrusion 18b and the recess 10b as a cavity.

In the present embodiment, a drain oil passage 186 (see FIGS. 8 and 9) is formed, e.g., between the sixth block 161 and the seventh block 162. The drain oil passage 186 is formed in both the seventh surface 17 and the ninth surface 19 by the third grooves 17a formed in the seventh surface 17 and the fourth grooves 19a formed in the ninth surface 19. The drain oil passage 186 communicates with the outside of the sixth block 161 and the seventh block 162 and drains hydraulic oil to the outside of the sixth block 161 and the seventh block 162. Neither protrusions nor recesses are formed around the drain oil passage 186.

For example, of the oil passages 182, 185 communicating with a switch valve 166 in the valve mounting portion 160, a large diameter oil passage that causes high flow rate hydraulic oil to flow therethrough communicates with another switch valve 166 in the valve mounting portion 160, communicates with another switch valve 166 in the valve mounting portion 160 via the large diameter oil passages 183 in the oil passage mounting portion 150, or communicates with the linear solenoid valves 170 or the solenoid valves 179 in the solenoid mounting portion 140 via the large diameter oil passages 183 in the oil passage mounting portion 150. For example, of the oil passages 182, 185 communicating with a switch valve 166 in the valve mounting portion 160, a small diameter oil passage that causes low flow rate hydraulic oil to flow therethrough communicates with another switch valve 166 in the valve mounting portion 160, communicates with another switch valve 166 in the valve mounting portion 160 via the small diameter oil passages 184 in the oil passage mounting portion 150, or communicates with the solenoid valves 179 in the solenoid mounting portion 140 via the small diameter oil passages 184 in the oil passage mounting portion 150. That is, at least a part of the oil passages 183, 184 in the oil passage mounting portion 150 allow the linear solenoid valves 170 in the solenoid mounting portion 140 to communicate with the switch valves 166 in the valve mounting portion 160.

In the above description, the first protrusion 15b formed on the fifth surface 15 and the first recess 16b formed in the sixth surface 16 are bonded to surround and seal the oil passages 183, 184 located in both the fifth surface 15 and the sixth surface 16. However, the present disclosure is not limited to the first protrusion 15b and the first recess 16b. That is, the protrusions and the recesses in other surfaces can also be formed so as to surround adjacent oil passages, whereby the oil passages can be sealed by bonding between the protrusion and the recess. In the present embodiment, the protrusion 11b and the recess 13b are bonded to surround and seal the oil passages 180, the protrusion 12b and the recess 14b are bonded to surround and seal the oil passages 181, the second protrusion 17b and the second recess 19b are bonded to surround and seal the second oil passages 182, and the protrusion 18b and the recess 10b are bonded to surround and seal the oil passages 185.

As in the first embodiment, the aforementioned valve body of the hydraulic control device 104 for the automatic transmission 3 of the present embodiment is manufactured by the DSI method. Accordingly, when the valve body of the hydraulic control device 104 is manufactured, each of the first to eighth blocks 141 to 163 is primarily molded by injection molding, and opposing dies are moved relative to each other without removing the first to eighth blocks 141 to 163 from a mold. By this die slide operation, a part of the layers is stacked with a protrusion being fitted in a recess, and a synthetic resin is injected into a cavity to perform secondary molding, whereby the stacked layers are joined. The die slide operation and the stacking operation are performed for all of the bonding surfaces of the first to eighth blocks 141 to 163 to form the valve body. In the present embodiment, the sealing member that joins the stacked blocks is an injection molding material. However, the present disclosure is not limited to this. For example, the sealing member may be an adhesive. That is, the protrusion and the recess in each layer may be joined by adhesion. In this case, the valve body can be assembled at low cost.

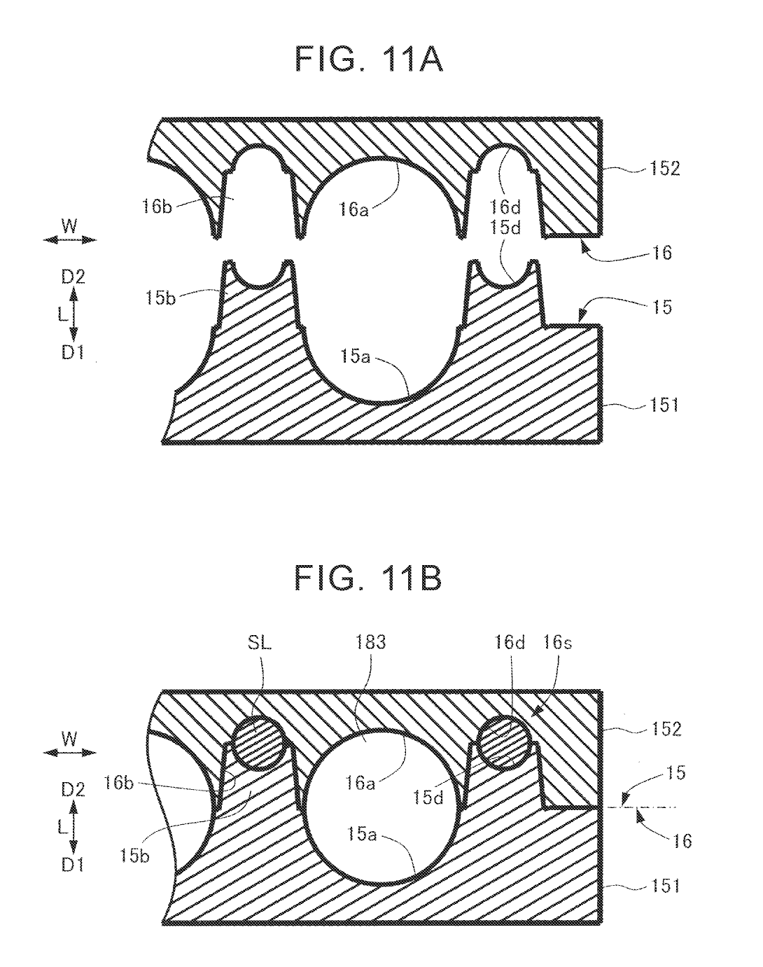

The configuration of the bonded portion between the protrusion and the recess formed in each surface will be described in detail with reference to FIGS. 11A to 14. For example, the clearance 16s between the first protrusion 15b on the fifth surface 15 and the first recess 16b in the sixth surface 16 will be described. As shown in FIGS. 11A and 11B, the first protrusion 15b has, in its distal end, a protrusion-side groove 15d that is a groove with a semicircular section having a chord on the first recess 16b side. That is, the protrusion-side groove 15d opens toward the first recess 16b. The first recess 16b has, in its bottom, a recess-side groove 16d that is a groove with a semicircular section having a chord on the first protrusion 15b side. That is, the first recess 16b opens toward the first protrusion 15b. The first protrusion 15b is fitted in the first recess 16b, whereby the protrusion-side groove 15d and the recess-side groove 16d form the clearance 16s with a circular section.

When the valve body is manufactured by the DSI method, the fourth block 151 and the fifth block 152 are injection molded. The fourth block 151 and the fifth block 152 are then stacked such that the first protrusion 15b is fitted in the first recess 16b. The sealing member SL made of a synthetic resin is injected into the clearance 16s serving as a cavity to perform injection molding, whereby the stacked layers are joined.

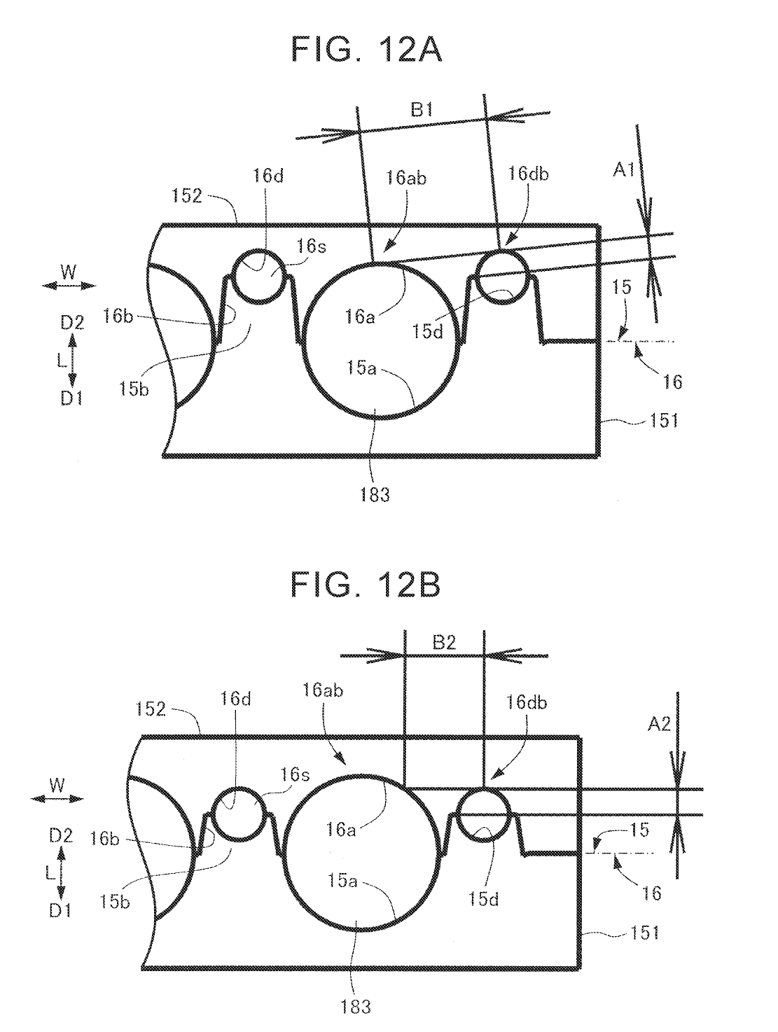

In the aforementioned secondary molding of the DSI method, an oil-passage-side partition wall the recess of the clearance into which the sealing member SL for secondary molding is injected may collapse into an adjacent oil passage due to the injection pressure, resulting in leakage of the sealing member SL into the oil passage and formation of an unwanted portion. As a solution, in the present embodiment, a bottom 16db of the first recess 16b is located at a greater depth from the sixth surface 16 than a bottom 16ab of the large diameter groove 16a, as shown in FIG. 12A. This increases a distance B1 between the large diameter oil passage 183 and the clearance 16s. That is, the distance B1 between the large diameter oil passage 183 and the clearance 16s shown in FIG. 12A is larger than a distance B2 between the large diameter oil passage 183 and the clearance 16s in the case where the bottom 16db of the first recess 16b is located at a smaller depth from the sixth surface 16 than the bottom 16ab of the large diameter groove 16a as shown in FIG. 12B. The partition wall between the large diameter oil passage 183 and the clearance 16s thus has a larger thickness, which improves rigidity against the injection pressure of the sealing member SL.

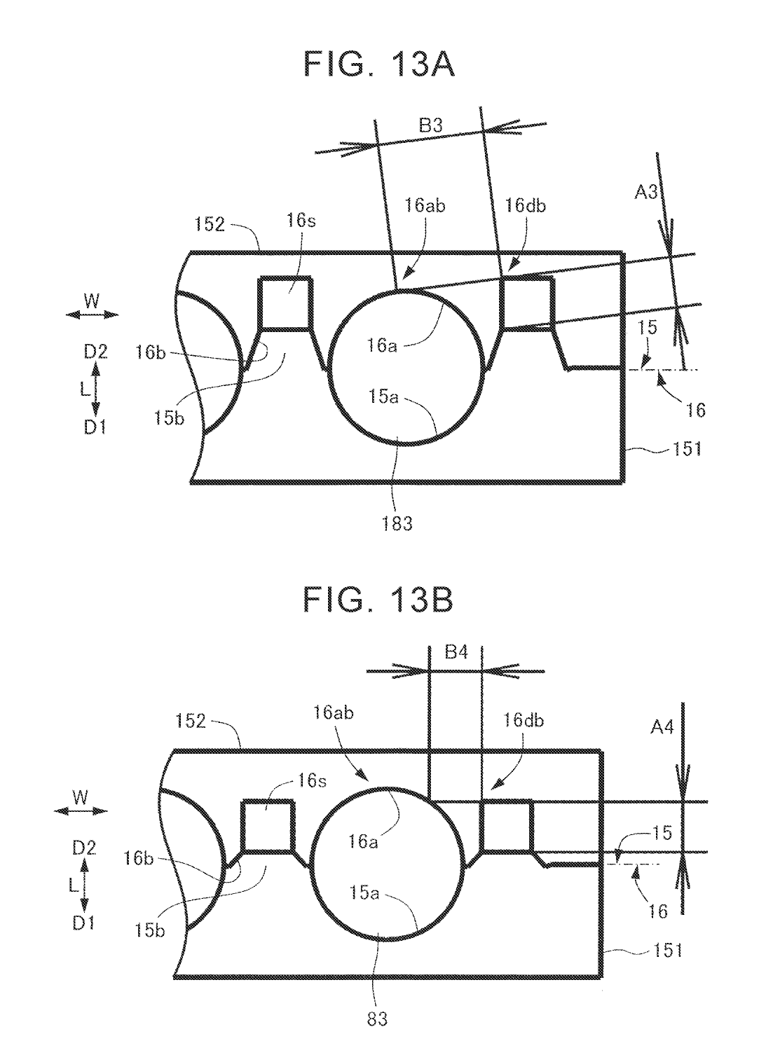

The clearance 16s is formed by combination of two groove halves, namely the protrusion-side groove 15d with a semicircular section and the recess-side groove 16d with a semicircular section. In the case where the clearance 16s is formed by combination of two halves as shown in FIG. 12A, an area A1 of the wall surface in the lateral direction W is smaller than areas A3, A4 of the wall surfaces in the lateral direction W in the case where the clearance 16s is not formed by combination of two halves as shown in FIGS. 13A and 13B. The pressure that causes the partition wall to collapse into the large diameter oil passage 183 due to the injection pressure of the sealing member SL can thus be reduced by half. This restrains defective sealing in secondary molding due to collapse of the partition wall located between the large diameter oil passage 183 and the clearance 16s.

Moreover, since the clearance 16s shown in FIG. 12A is shifted by a larger amount in the stacking direction L with respect to the large diameter oil passage 183 than the clearance 16s shown in FIG. 12B, the clearance 16s shown in FIG. 12A can be located closer to the large diameter oil passage 183 in the lateral direction W. The bottom 16db of the first recess 16b is located at a greater depth than the bottom 16ab of the large diameter groove 16a. Accordingly, reduction in size of the valve body in the lateral direction W is achieved while ensuring rigidity thereof.

If the clearance into which the sealing member for secondary molding is injected has a sectional shape with a right angle or an acute angle, the sealing member is first cured in the right-angled portion or the acute-angled portion because the sealing member is cooled extremely faster in the right-angled portion or the acute-angled portion than in other portions. That is, the sealing member SL in the right-angled portion or the acute-angled portion is rapidly cooled by two surfaces sandwiching the right-angled portion or the acute-angled portion and therefore is cured before the sealing member SL in other portions are cured, which may hinder welding of the sealing member SL. The sealing member may therefore not be welded to the primary molded articles, resulting in reduced bonding strength and insufficient pressure resistance of the oil passages. As a solution, in the present embodiment, the clearance 16s has a circular section, as shown in FIG. 12A. In this case, unlike in the case of the clearance 16s having a right-angled portion or an acute-angled portion as shown in FIG. 13A, the sealing member SL does not have a portion that is cured extremely fast and therefore the entire sealing member SL is uniformly cured in the clearance 16s. Accordingly, the sealing member SL is sufficiently welded to the primary molded articles, which provides sufficient bonding strength and enables the oil passages to have sufficient pressure resistance.

The clearance 16s between the first protrusion 15b on the fifth surface 15 and the first recess 16b in the sixth surface 16 is described above as the configuration of the bonded portion between the protrusion and the recess formed in each surface. However, this configuration is not limited to the clearance 16s between the first protrusion 15b and the first recess 16b. That is, the clearance between the protrusion and the recess in other surfaces may have a similar configuration, and this configuration can be applied to any of the clearance 13s between the protrusion 11b on the first surface 11 and the recess 13b in the third surface 13, the clearance 14s between the protrusion 12b on the second surface 12 and the recess 14b in the fourth surface 14, the clearance 19s between the second protrusion 17b on the seventh surface 17 and the second recess 19b in the ninth surface 19, and the clearance 10s between the protrusion 18b on the eighth surface 18 and the recess 10b in the tenth surface 10.

As described above, according to the hydraulic control device 104 for the automatic transmission 3 of the present embodiment, as shown in FIG. 10, the first protrusion 15b and the first recess 16b, which are formed in the opposing surfaces 15, 16, are fitted together between adjacent ones of the oil passages 183, 184, and the fourth block 151 and the fifth block 152 are joined by injection molding using the clearance 16s between the first protrusion 15b and the first recess 16b as a cavity. Such fitting between the first protrusion 15b and the first recess 16b formed in the surfaces 15, 16 forms a complex shape between adjacent ones of the oil passages 183, 184 and thus enhances sealability, as compared to the case where the surfaces are flat between adjacent ones of the oil passages 183, 184.

According to the hydraulic control device 104 of the present embodiment, as shown in FIG. 12A, the bottom 16db of the first recess 16b is located at a greater depth from the sixth surface 16 than the bottom 16ab of the large diameter groove 16a. Accordingly, the distance B1 between the large diameter oil passage 183 and the clearance 16s shown in FIG. 12A is larger than the distance B2 between the large diameter oil passage 183 and the clearance 16s in the case where the bottom 16db of the first recess 16b is located at a smaller depth from the sixth surface 16 than the bottom 16ab of the large diameter groove 16a as shown in FIG. 12B. Similarly, as shown in FIG. 13A, even in the case where the clearance 16s has a rectangular section, the distance B3 between the large diameter oil passage 183 and the clearance 16s shown in FIG. 13A is larger than the distance B4 between the large diameter oil passage 183 and the clearance 16s in the case where the bottom 16db of the first recess 16b is located at a smaller depth from the sixth surface 16 than the bottom 16ab of the large diameter groove 16a as shown in FIG. 13B. The partition wall between the large diameter oil passage 183 and the clearance 16s thus has a larger thickness, which improves rigidity against the injection pressure of the sealing member SL.

According to the hydraulic control device 104 of the present embodiment, as shown in FIG. 12A, the clearance 16s is formed by combination of two groove halves, namely the protrusion-side groove 15d with a semicircular section and the recess-side groove 16d with a semicircular section. In the case where the clearance 16s is formed by combination of two halves as shown in FIG. 12A, the area A1 of the wall surface in the lateral direction W is smaller than the areas A3, A4 of the wall surfaces in the lateral direction W in the case where the clearance 16s is not formed by combination of two halves as shown in FIGS. 13A and 13B. The pressure that causes the partition wall to collapse into the large diameter oil passage 183 due to the injection pressure of the sealing member SL can thus be reduced by half. This restrains defective sealing in secondary molding due to collapse of the partition wall located between the large diameter oil passage 183 and the clearance 16s. Even in the case where the bottom 16db of the first recess 16b is located at a smaller depth from the sixth surface 16 than the bottom 16ab of the large diameter groove 16a, forming the clearance 16s by combination of two groove halves, namely the protrusion-side groove 15d and the recess-side groove 16d, can reduce the pressure that causes the partition wall to collapse into the large diameter oil passage 183 due to the injection pressure of the sealing member SL by half as in the example shown in FIG. 12A.

According to the hydraulic control device 104 of the present embodiment, as shown in FIG. 12A, the clearance 16s has a circular section. In this case, unlike in the case of the clearance 16s having a right-angled portion or an acute-angled portion as shown in FIG. 13A, the sealing member SL does not have a portion that is cured extremely fast and therefore the entire sealing member SL is uniformly cured in the clearance 16s. Accordingly, the sealing member SL is sufficiently welded to the primary molded articles, which provides sufficient bonding strength and enables the oil passages to have sufficient pressure resistance. Even in the case where the bottom 16db of the first recess 16b is located at a smaller depth from the sixth surface 16 than the bottom 16ab of the large diameter groove 16a, forming the clearance 16s with a circular section provides sufficient bonding strength and enables the oil passages to have sufficient pressure resistance as in the example shown in FIG. 12A.

The aforementioned hydraulic control device 104 of the present embodiment is described with respect to the case where the bottom 16db of the first recess 16b is located at a greater depth from the sixth surface 16 than the bottom 16ab of the large diameter groove 16a as shown in FIG. 12A. However, the present disclosure is not limited to this. For example, as shown in FIGS. 12B and 13B, the bottom 16db of the first recess 16b may be located at a smaller depth from the sixth surface 16 than the bottom 16ab of the large diameter groove 16a. In this case, the thickness in the stacking direction L can be reduced as compared to the case where the bottom 16db of the first recess 16b is located at a greater depth than the bottom 16ab of the large diameter groove 16a, whereby reduction in size in the stacking direction L can be achieved.

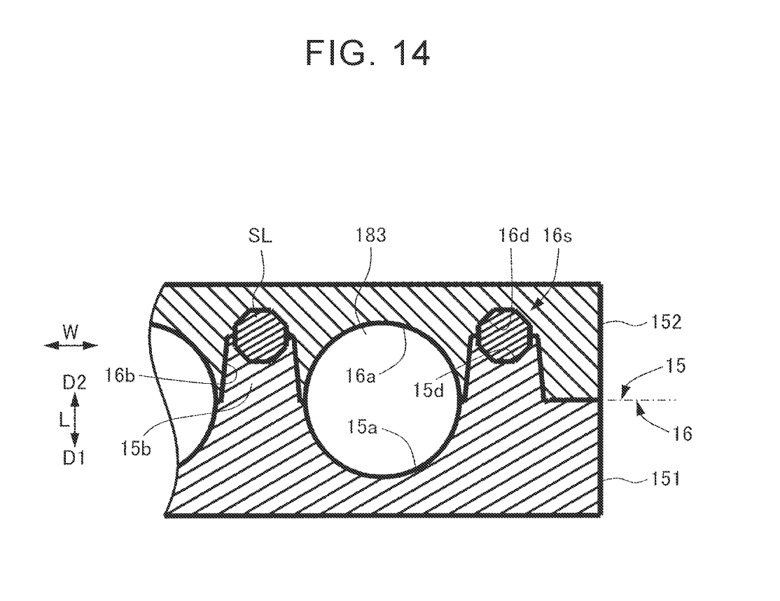

The aforementioned hydraulic control device 104 of the present embodiment is described with respect to the case where the clearance 16s has a circular section as shown in FIG. 12A. However, the present disclosure is not limited to this. For example, the clearance 16s may have a regular octagonal section as shown in FIG. 14, a regular hexagonal section, or a polygonal section with rounded corners. In any of these cases, the sectional shape does not include a corner with an angle equal to or smaller than a right angle. In this case, unlike in the case of the clearance 16s having a right-angled portion or an acute-angled portion, the sealing member SL does not have a portion that is cured extremely fast and therefore the entire sealing member SL is uniformly cured in the clearance 16s. Accordingly, the sealing member SL is sufficiently welded to the primary molded articles, which provides sufficient bonding strength and enables the oil passages to have sufficient pressure resistance.

The present embodiment includes at least the following configuration. In the hydraulic control device (104) for the automatic transmission (3) according to the present embodiment, the first protrusion (15b) is formed on the first layer (151) and the first recess (16b) is formed in the second layer (152), and a bottom (16db) of the first recess (16b) is located at a greater depth from the second parting surface (16) than a bottom (16ab) of the second groove (16a). According to this configuration, the distance (B1) between the first oil passage (183) and the clearance (16s) is larger than the distance (B2) between the first oil passage (183) and the clearance (16s) in the case where the bottom (16db) of the first recess (16b) is located at a smaller depth from the second parting surface (16) than the bottom (16ab) of the second groove (16a). A partition wall between the first oil passage (183) and the clearance (16s) thus has a larger thickness, which improves rigidity against the injection pressure of the sealing member (SL). This restrains the partition wall of the clearance (16s) from collapsing into an adjacent first oil passage (183) due to the injection pressure and thus restrains formation of an unwanted portion due to leakage of the sealing member (SL) into the first oil passage (183).

In the hydraulic control device (104) for the automatic transmission (3) according to the present embodiment, the first protrusion (15b) has, in its distal end, a protrusion-side groove (15d) that is a groove with a semicircular section having a chord on the first recess (16b) side, the first recess (16b) has, in its bottom (16db), a recess-side groove (16d) that is a groove with a semicircular section having a chord on the first protrusion (15b) side, and the first protrusion (15b) is fitted in the first recess (16b), whereby the protrusion-side groove (15d) and the recess-side groove (16d) form clearance (16s) with a circular section. According to this configuration, the clearance (16s) is formed by combination of two halves. Accordingly, the area (A1) of the wall surface on the first oil passage (183) side is smaller than the area (A3, A4) of the wall surface on the first oil passage (183) in the case where the clearance (16s) is not formed by combination of two halves. The pressure that causes the partition wall to collapse into the first oil passage (183) due to the injection pressure of the sealing member (SL) can thus be reduced by half. This restrains defective sealing in secondary molding due to collapse of the partition wall located between the first oil passage (183) and the clearance (16s). The clearance (16s) has a circular section. In this case, unlike in the case of the clearance (16s) having a right-angled portion or an acute-angled portion in section, the sealing member (SL) does not have a portion that is cured extremely fast and therefore the entire sealing member (SL) is uniformly cured in the clearance (16s). Accordingly, the sealing member (SL) is sufficiently welded to the primary molded articles, which provides sufficient bonding strength and enables the oil passages to have sufficient pressure resistance.

In the hydraulic control device (104) for the automatic transmission (3) according to the present embodiment, the distal end of the first protrusion (15b) has a rectangular section, the bottom of the first recess (16b) has a rectangular section, and the first protrusion (15b) is fitted in the first recess (16b) so that clearance (16s) with a rectangular section is formed therebetween. According to this configuration, a sealing member or an adhesive is injected into the clearance (16s). This further improves sealability and strength because the sealing member or the adhesive can be injected extensively and effectively.

In the hydraulic control device (104) for the automatic transmission (3) according to the present embodiment, the first protrusion (15b) has, in distal end, a protrusion-side groove (15d) that is a groove having a half polygonal section with only an obtuse angle and opening toward the first recess (16b), the first recess (16b) has, in its bottom, a recess-side groove (16d) that is a groove having a half polygonal section with only an obtuse angle and opening toward the first protrusion (15b), and the first protrusion (15b) is fitted in the first recess (16b), whereby the protrusion-side groove (15d) and the recess-side groove (16d) form clearance (16s) having a polygonal section with only an obtuse angle. According to this configuration, unlike in the case of the clearance (16s) having a right-angled portion or an acute-angled portion in section, the sealing member (SL) does not have a portion that is cured extremely fast and therefore the entire sealing member (SL) is uniformly cured in the clearance (16s). Accordingly, the sealing member (SL) is sufficiently welded to the primary molded articles, which provides sufficient bonding strength and enables the oil passages to have sufficient pressure resistance.

### INDUSTRIAL APPLICABILITY

The hydraulic control device for the automatic transmission according to the present disclosure is preferably used in automatic transmissions that can be mounted on, e.g., vehicles etc. and that particularly engage and disengage engagement elements etc. by supplying and cutting off supply of oil pressures.

1-14. (canceled)

15. A hydraulic control device for an automatic transmission, the hydraulic control device comprising:
a first layer having a first parting surface and a plurality of first grooves formed in the first parting surface; and
a second layer that has a second parting surface and a plurality of second grooves formed in the second parting surface and facing the plurality of first grooves, and that is stacked on the first layer in a stacking direction with the second parting surface facing the first parting surface of the first layer, so that the plurality of first grooves and the plurality of second grooves form a plurality of first oil passages, wherein
a first protrusion is formed either between adjacent grooves of the plurality of first grooves on the first parting surface of the first layer so as to protrude toward the second layer or between adjacent grooves of the plurality of second grooves on the second parting surface of the second layer so as to protrude toward the first layer,
a first recess in which the first protrusion is fitted is either formed in the second parting surface of the second layer if the first protrusion is formed between the adjacent grooves of the plurality of first grooves, or formed in the first parting surface of the first layer if the first protrusion is formed between the adjacent grooves of the plurality of second grooves, and
the first layer and the second layer are stacked such that the first protrusion is fitted in the first recess between adjacent ones of the first oil passages, and are joined via the first protrusion and the first recess.

16. The hydraulic control device for the automatic transmission according to claim 15, wherein
the first protrusion is formed on the first layer and the first recess is formed in the second layer, and
a bottom of the first recess is located at a greater depth from the second parting surface than a bottom of the second groove.

17. The hydraulic control device for the automatic transmission according to claim 16, wherein
the first protrusion has, in a distal end of the first protrusion, a protrusion-side groove that is a groove with a semicircular section having a chord on a first recess side,
the first recess has, in a bottom of the first recess, a recess-side groove that is a groove with a semicircular section having a chord on a first protrusion side, and
the first protrusion is fitted in the first recess such that the protrusion-side groove and the recess-side groove form a clearance with a circular section.

18. The hydraulic control device for the automatic transmission according to claim 17, wherein
the first protrusion is formed on the first layer, the first recess is formed in the second layer, and the second grooves have a semicircular section.

19. The hydraulic control device for the automatic transmission according to claim 18, wherein
clearance is provided between the first protrusion and the first recess, and a sealing member is injected into the clearance to join the first protrusion and the first recess.

20. The hydraulic control device for the automatic transmission according to claim 19, wherein
the sealing member is an injection molding material, and the injection molding material is injected into the clearance serving as a cavity to join the first protrusion and the first recess by injection molding.

21. The hydraulic control device for the automatic transmission according to claim 20, wherein
each of the first layer and the second layer is formed by primary injection molding, and the first layer and the second layer are joined by secondary injection molding using the clearance as a cavity.

22. The hydraulic control device for the automatic transmission according to claim 21, further comprising:
a third layer having a third parting surface and a plurality of third grooves formed in the third parting surface, wherein:
the second layer further has a fourth parting surface located on an opposite side of the second layer from the second parting surface, and a plurality of fourth grooves formed in the fourth parting surface and facing the plurality of third grooves, and is stacked on the third layer with the fourth parting surface facing the third parting surface of the third layer, so that the plurality of third grooves and the plurality of fourth grooves form a plurality of second oil passages,
a second protrusion is formed either between adjacent grooves of the plurality of fourth grooves on the fourth parting surface of the second layer so as to protrude toward the third layer or between adjacent grooves of the plurality of third grooves on the third parting surface of the third layer so as to protrude toward the second layer,
a second recess in which the second protrusion is fitted is either formed in the third parting surface of the third layer if the second protrusion is formed between the adjacent grooves of the plurality of fourth grooves, or formed in the fourth parting surface of the second layer if the second protrusion is formed between the adjacent grooves of the plurality of third grooves, and
the second layer and the third layer are stacked such that the second protrusion is fitted in the second recess between adjacent ones of the second oil passages, and are joined via the second protrusion and the second recess.

23. The hydraulic control device for the automatic transmission according to claim 22, wherein
the second protrusion is formed on the third layer, the second recess is formed in the second layer, and the fourth grooves have a semicircular section.

24. The hydraulic control device for the automatic transmission according to claim 23, wherein
the first protrusion is formed on the first layer, the first recess is formed in the second layer, the second grooves have a semicircular section, the second protrusion is formed on the third layer, the second recess is formed in the second layer, and the fourth grooves have a semicircular section, and
the second grooves and the fourth grooves are arranged in a direction perpendicular to the stacking direction such that the fourth groove is located between the second grooves.

25. The hydraulic control device for the automatic transmission according to claim 16, wherein
a distal end of the first protrusion has a rectangular section,
a bottom of the first recess has a rectangular section, and
the first protrusion is fitted in the first recess so that clearance with a rectangular section is formed therebetween.

26. The hydraulic control device for the automatic transmission according to claim 25, wherein
the first protrusion is formed on the first layer, the first recess is formed in the second layer, and the second grooves have a semicircular section.

27. The hydraulic control device for the automatic transmission according to claim 16, wherein
the first protrusion and the first recess are joined by adhesion.

28. The hydraulic control device for the automatic transmission according to claim 27, further comprising:
a third layer having a third parting surface and a plurality of third grooves formed in the third parting surface, wherein:
the second layer further has a fourth parting surface located on an opposite side of the second layer from the second parting surface, and a plurality of fourth grooves formed in the fourth parting surface and facing the plurality of third grooves, and is stacked on the third layer with the fourth parting surface facing the third parting surface of the third layer, so that the plurality of third grooves and the plurality of fourth grooves form a plurality of second oil passages,
a second protrusion is formed either between adjacent grooves of the plurality of fourth grooves on the fourth parting surface of the second layer so as to protrude toward the third layer or between adjacent grooves of the plurality of third grooves on the third parting surface of the third layer so as to protrude toward the second layer,
a second recess in which the second protrusion is fitted is either formed in the third parting surface of the third layer if the second protrusion is formed between the adjacent grooves of the plurality of fourth grooves, or formed in the fourth parting surface of the second layer if the second protrusion is formed between the adjacent grooves of the plurality of third grooves, and
the second layer and the third layer are stacked such that the second protrusion is fitted in the second recess between adjacent ones of the second oil passages, and are joined via the second protrusion and the second recess.

29. The hydraulic control device for the automatic transmission according to claim 16, wherein
the first protrusion has, in a distal end of the first protrusion, a protrusion-side groove that is a groove having a half polygonal section with only an obtuse angle and opening toward the first recess,
the first recess has, in a bottom of the first recess, a recess-side groove that is a groove having a half polygonal section with only an obtuse angle and opening toward the first protrusion, and
the first protrusion is fitted in the first recess, whereby the protrusion-side groove and the recess-side groove form clearance having a polygonal section with only an obtuse angle.

30. The hydraulic control device for the automatic transmission according to claim 15, wherein
the first protrusion has, in a distal end of the first protrusion, a protrusion-side groove that is a groove with a semicircular section having a chord on a first recess side,
the first recess has, in a bottom of the first recess, a recess-side groove that is a groove with a semicircular section having a chord on a first protrusion side, and
the first protrusion is fitted in the first recess, whereby the protrusion-side groove and the recess-side groove form clearance with a circular section.

31. The hydraulic control device for the automatic transmission according to claim 15, wherein
a distal end of the first protrusion has a rectangular section,
a bottom of the first recess has a rectangular section, and
the first protrusion is fitted in the first recess so that clearance with a rectangular section is formed therebetween.

32. The hydraulic control device for the automatic transmission according to claim 15, wherein
the first protrusion is formed on the first layer, the first recess is formed in the second layer, and the second grooves have a semicircular section.

33. The hydraulic control device for the automatic transmission according to claim 15, wherein
clearance is provided between the first protrusion and the first recess, and a sealing member is injected into the clearance to join the first protrusion and the first recess.

34. A method for manufacturing a hydraulic control device for an automatic transmission, the method comprising:
injection-molding each of a first layer that has a first parting surface, a plurality of first grooves formed in the first parting surface, and a protrusion or a recess formed between adjacent ones of the first grooves in the first parting surface and a second layer that has a second parting surface, a plurality of second grooves formed in the second parting surface and facing the plurality of first grooves, and a recess or a protrusion formed in the second parting surface so as to be fitted with the protrusion or the recess of the first layer with clearance in a stacking direction; and
stacking the first layer and the second layer such that the protrusion is fitted in the recess, and joining the first layer and the second layer by secondary injection molding using the clearance as a cavity.
